(19) United States
(12) Patent Application Publication
(10) Pub. No.: US 2026/0228025 A1
(43) Pub. Date: Aug. 6, 2026

(54) COMPUTER-READABLE STORAGE MEDIUM STORING A PROGRAM, INFORMATION PROCESSING APPARATUS, AND METHOD

(71) Applicant: CANON KABUSHIKI KAISHA, Tokyo (JP)

(72) Inventor: HARUNA SATO, Tokyo (JP)

(21) Appl. No.: 19/457,425

(22) Filed: Jan. 23, 2026

(30) Foreign Application Priority Data
Jan. 27, 2025 (JP) 2025-011658

(51) Int. Cl. G06F 9/451; G06F 3/12

(52) U.S. Cl. CPC G06F 9/453; G06F 3/1205; G06F 3/126

(57) ABSTRACT

A computer-readable storage medium storing a program configured to cause a computer of an information processing apparatus to function as: a detecting unit configured to detect a communication apparatus connected to the information processing apparatus; and a display unit configured to, in a case where the communication apparatus that is connected to the information processing apparatus only through a Universal Serial Bus (USB) interface is detected, display a guidance screen for accepting a designation of an external interface to be used for connecting the communication apparatus to the information processing apparatus.

### BACKGROUND

### Field of the Technology

The present disclosure relates to a computer-readable storage medium storing a program, an information processing apparatus, and a method.

### Description of the Related Art

As a method for connecting an information processing apparatus and a communication apparatus to each other, there is a method in which the communication apparatus is connected to a network, and the information processing apparatus and the communication apparatus then connect to each other over the network. As another such connection method, there is also a method in which the information processing apparatus and the communication apparatus connect to each other without connecting the communication apparatus to the network. When the communication apparatus is connected to the network, a plurality of information processing apparatuses can be connected to the communication apparatus, Internet-based services can be used, and the like.

According to Japanese Patent Laid-Open No. 2023-118467, an information processing apparatus determines whether it is necessary to connect an image processing apparatus to a predetermined network connected to the Internet. When the information processing apparatus determines that it is necessary to connect to the predetermined network, the information processing apparatus executes processing for causing the image processing apparatus to connect to the network.

### SUMMARY

The present disclosure provides a technique for improving usability when connecting a communication apparatus to an information processing apparatus.

The present disclosure in one aspect provides a non-transitory computer-readable storage medium storing a program configured to cause a computer of an information processing apparatus to function as: a detecting unit configured to detect a communication apparatus connected to the information processing apparatus; and a display unit configured to, in a case where the communication apparatus that is connected to the information processing apparatus only through a Universal Serial Bus (USB) interface is detected, display a guidance screen for accepting a designation of an external interface to be used for connecting the communication apparatus to the information processing apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating the configuration of a system.

FIG. 2 is a diagram illustrating the configurations of apparatuses.

FIGS. 3A and 3B are examples of a connection screen displayed by an information processing apparatus.

FIGS. 4A and 4B are flowcharts illustrating processing performed by the information processing apparatus.

FIG. 5 is a flowchart illustrating processing performed by the information processing apparatus.

FIG. 6 is a flowchart illustrating processing performed by the information processing apparatus.

FIG. 7 is a flowchart illustrating processing performed by the information processing apparatus.

FIG. 8 is a flowchart illustrating processing performed by the information processing apparatus.

FIG. 9 is a flowchart illustrating processing performed by a communication apparatus.

FIG. 10 is a diagram illustrating a file downloaded from a server.

FIGS. 11A to 11C are diagrams illustrating user interface screens.

FIGS. 12A to 12D are diagrams illustrating user interface screens.

FIGS. 13A to 13C are diagrams illustrating user interface screens.

FIGS. 14A and 14B are diagrams illustrating user interface screens.

FIGS. 15A and 15B are flowcharts illustrating processing performed by the information processing apparatus.

FIGS. 16A and 16B are flowcharts illustrating processing performed by the information processing apparatus.

FIGS. 17A and 17B are diagrams illustrating user interface screens.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

With the past technique, if it is determined that it is not necessary to connect the communication apparatus to the network, processing for connecting the communication apparatus to the network is not executed. In such a case, even if the communication apparatus is connected to the network, and the information processing apparatus and the communication apparatus can be connected to each other, the user cannot recognize that connection method. There has thus been room for improvement in terms of usability when connecting the communication apparatus to the information processing apparatus.

The present disclosure provides a technique for improving usability when connecting a communication apparatus to an information processing apparatus.

### First Embodiment

An information processing apparatus and a communication apparatus included in a communication system according to the present embodiment will be described hereinafter. The information processing apparatus will also be referred to as a “terminal apparatus”. The present embodiment will describe a personal computer (PC) as an example of the information processing apparatus, but the information processing apparatus is not limited thereto. The information processing apparatus can be applied as a variety of devices, such as a smartphone, a tablet terminal, a Personal Digital Assistant (PDA), a digital camera, or the like. The present embodiment will also describe a printer as an example of the communication apparatus. The printer may be an ink jet printer that prints using ink, or a laser beam printer that prints using toner. The printer may be a full-color printer capable of color printing, or a black and white printer capable of black and white printing but not color printing. The communication apparatus according to the present embodiment is not limited to a printer, and the communication apparatus can be applied in any apparatus as long as the apparatus is capable of communicating wirelessly with the information processing apparatus. For example, the communication apparatus can be applied in a copier, a facsimile device, a scanner, a smartphone, a PC, a tablet terminal, a PDA, a digital camera, a music playback device, a television, a smart speaker, a robotic vacuum cleaner, an automatic cooking pot, a refrigerator, or the like. The communication apparatus can also be a multifunction peripheral provided with a plurality of functions, such as a copying function, a fax function, a printing function, and the like.

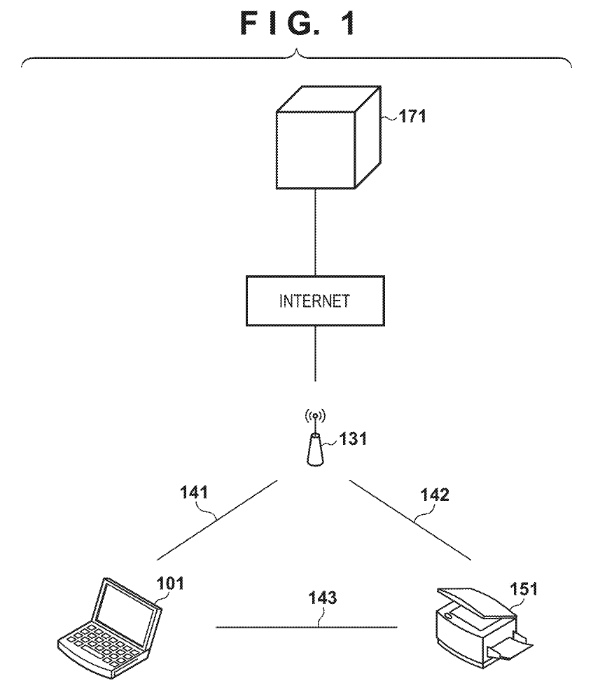

A system configuration for realizing the present embodiment will be described first. FIG. 1 is a diagram illustrating an example of the configuration of the communication system according to the present embodiment. This system includes a communication apparatus 151, an information processing apparatus 101, an access point (AP) 131, and an external server 171.

The information processing apparatus 101 is the information processing apparatus according to the present embodiment. The communication apparatus 151 is the communication apparatus according to the present embodiment. The AP 131 is an access point that is activated by an external apparatus outside both the information processing apparatus 101 and the communication apparatus 151. The external apparatus is, for example, a wireless local area network (LAN) router. The external server 171 is a server that can provide services over the Internet to devices connected to the AP 131.

When the communication apparatus 151 and the information processing apparatus 101 are connected to the AP 131, a LAN formed by the AP 131 includes the AP 131, the communication apparatus 151, and the information processing apparatus 101. On the other hand, a Wide Area Network (WAN) includes the AP 131 and the external server 171.

In the present embodiment, when an infrastructure connection (described later) is established, the information processing apparatus 101 can communicate with the communication apparatus 151 via the AP 131. Furthermore, when a direct connection (described later) is established, the information processing apparatus 101 can communicate directly with the communication apparatus 151 without going through the AP 131. Note that in the following, a “connection with an AP” corresponds to a connection to a network formed by the AP. Note that the AP may be capable of forming a plurality of networks simultaneously, and in such a case, the “connection with the AP” may be a connection to any one of the plurality of networks formed by the AP.

The present embodiment assumes that a connection 141 between the information processing apparatus 101 and the AP 131 and a connection 142 between the communication apparatus 151 and the AP 131 are connections using communication methods based on an IEEE 802.11 series standard. The communication method based on the IEEE 802.11 series standard is specifically Wireless Fidelity (Wi-Fi) (registered trademark). A connection 143 between the information processing apparatus 101 and the communication apparatus 151 is also assumed to be a connection using a communication method based on an IEEE 802.11 series standard. However, the communication method used for the connection 143 is not limited to these methods, and may be, for example, Bluetooth (registered trademark) Low Energy (BLE), Bluetooth Classic, Wi-Fi Aware, Near Field Communication (NFC), or the like. The AP 131 and the external server 171 can communicate over the Internet, and in a state where the AP 131 is connected to the Internet, apparatuses connected to the AP 131 (the information processing apparatus 101, the communication apparatus 151, and the like) can also use the Internet. Note that the connection 141 between the information processing apparatus 101 and the AP 131 and the connection 142 between the communication apparatus 151 and the AP 131 may be wired LAN connections.

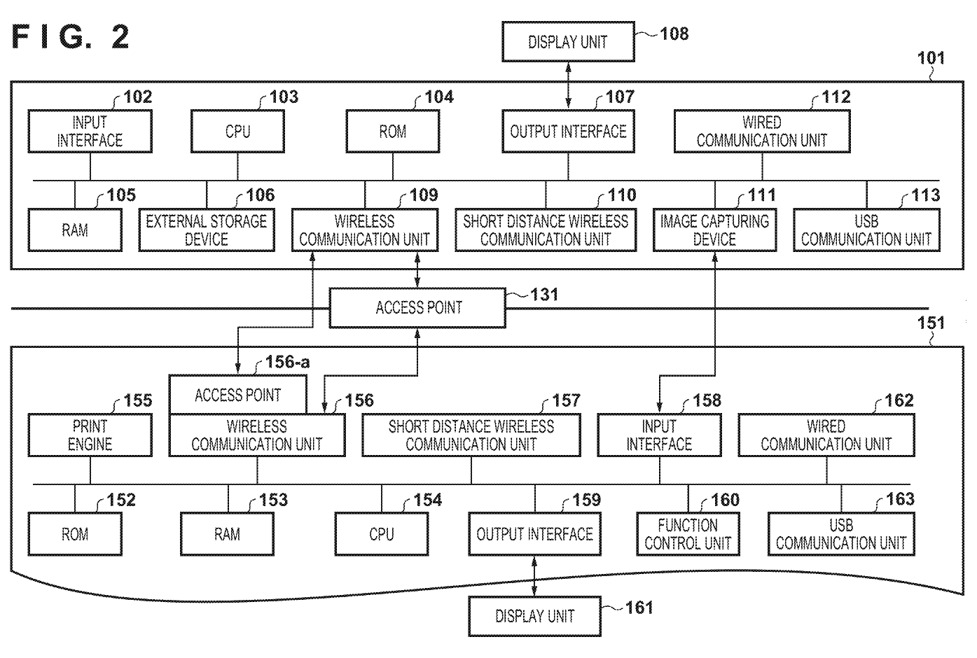

The configuration of the information processing apparatus according to the present embodiment, and the communication apparatus capable of communicating with the information processing apparatus according to the present embodiment, will be described next with reference to the block diagram in FIG. 2. Although the present embodiment will describe the following configuration as an example, the present embodiment can be applied as any apparatus capable of communicating with the communication apparatus, and the functions are not particularly limited to those illustrated here.

The information processing apparatus 101 includes an input interface 102, a CPU 103, a ROM 104, a RAM 105, an external storage device 106, an output interface 107, a display unit 108, a wireless communication unit 109, a short-range wireless communication unit 110, an image capturing device 111, a wired communication unit 112, a Universal Serial Bus (USB) communication unit 113, and the like. A computer of the information processing apparatus 101 is constituted by the CPU 103, the ROM 104, the RAM 105, and the like. Although the information processing apparatus 101 is assumed to be a device such as a smartphone, the information processing apparatus 101 is not limited to a smartphone.

The input interface 102 is an interface capable of accepting data inputs, operational instructions, and the like from a user, and is constituted by a physical keyboard, buttons, a touch panel, or the like. Note that the output interface 107 (described later) and the input interface 102 may be implemented by the same configuration, with that configuration both outputting screens and accepting operations from the user.

The CPU 103 is a system control unit, and controls the information processing apparatus 101 as a whole. In the present embodiment, the CPU 103 controls the content displayed in the display unit 108 (display control) and the like.

The ROM 104 stores fixed data such as control programs executed by the CPU 103, data tables, an operating system (“OS”, hereinafter) program, and the like. In the present embodiment, the control programs stored in the ROM 104 perform software execution control, such as scheduling, task switching, interrupt processing, and the like, under the management of the embedded OS stored in the ROM 104. The present embodiment will describe an example in which the OS of the information processing apparatus 101 is the Windows (registered trademark) OS provided by Microsoft Corporation. Note that the OS of the information processing apparatus 101 is not limited thereto, and may be another OS, such as the Android (registered trademark) OS or the Chrome (registered trademark) OS, both provided by Google, or Mac (registered trademark) OS provided by Apple. In the present embodiment, the ROM 104 stores a setup application program (“setup app” hereinafter). The setup app is installed in the information processing apparatus 101 from the outside by a store application program, for example. The setup app is an app provided by the vendor of the communication apparatus 151. Note that the setup app may have other functions aside from the network setup function (connection setting; described later) of the communication apparatus 151. Specifically, the other functions include a function for transmitting a print job for causing the communication apparatus 151 to print (a print job transmission function), a function for transmitting a scan job for causing the communication apparatus 151 to scan (a scan job transmission function), and the like. Note that processing described as processing executed by the OS in the present embodiment is, strictly speaking, processing executed by the CPU 103 in accordance with programs within the OS. Likewise, processing described as processing performed by an app is, strictly speaking, processing performed by the CPU 103 in accordance with programs within the app.

The RAM 105 is constituted by Static Random Access Memory (SRAM) or the like that requires a backup power source. Note that the RAM 105 holds data by using a primary battery for data backup (not shown) and can therefore store important data such as program control variables in a non-volatile state. A memory area for storing setting information of the information processing apparatus 101, management data of the information processing apparatus 101, and the like is also provided in the RAM 105. The RAM 105 is used as a main memory and a working memory for the CPU 103.

Additionally, the external storage device 106 includes various types of programs, such as a print information generation program that generates print information which can be interpreted by the communication apparatus 151, an information transmission/reception control program that transmits and receives information to and from the connected communication apparatus 151 through the wireless communication unit 109, and the like. The external storage device 106 also stores various types of information used by these programs, image data obtained from other information processing apparatuses, the Internet, and the like.

The output interface 107 is an interface for controlling the display unit 108 to display data, make notifications of the state of the information processing apparatus 101, and the like.

The display unit 108 is constituted by light-emitting diodes (LEDs), a liquid crystal display (LCD), or the like, and displays data, makes notifications regarding the state of the information processing apparatus 101, and the like. Note that inputs from the user can be accepted through the display unit 108 by providing, on the display unit 108, a software keyboard including numerical value input keys, a mode setting key, a confirm key, a cancel key, a power key, and the like. The present embodiment assumes that the display unit 108 is a touch panel, and can accept operations from a user by the user’s finger, a stylus, or the like.

The wireless communication unit 109 is an element for connecting to the communication apparatus 151, the AP 131, and the like wirelessly and communicating data, and includes a wireless LAN interface. For example, the wireless communication unit 109 may communicate directly with the communication apparatus 151 wirelessly, or may communicate via the AP 131 outside the information processing apparatus 101, the communication apparatus 151, and the like. Although the present embodiment assumes that Wi-Fi, which is a communication method based on the IEEE 802.11 standard, is used as the wireless communication method of the wireless communication unit 109, Bluetooth Classic or the like may be used instead. The present embodiment also assumes that the wireless LAN is a network using Wi-Fi. Note that a connection using a method in which the information processing apparatus 101 and the communication apparatus 151 connect directly without going through an external AP will be referred to as a “direct connection” in the present embodiment. A connection using a method in which the information processing apparatus 101 and the communication apparatus 151 connect via an external AP will be referred to as an “infrastructure connection”.

The short-range wireless communication unit 110 is an element for communicating data with devices such as the communication apparatus 151 through a short-range wireless communication method and communicates using a communication method different from that of the wireless communication unit 109. The short-range wireless communication unit 110 can connect to a short-range wireless communication unit 157 in the communication apparatus 151. Note that BLE, Bluetooth Classic, Wi-Fi Aware, NFC, and the like can be given as examples of the communication method of the short-range wireless communication unit 110.

The image capturing device 111 is a device that converts images captured by an image sensor into digital data. The digital data is initially stored in the RAM 105. The digital data is then converted to a predetermined image format by a program executed by the CPU 103, and the resulting data is stored in the external storage device 106 as image data.

The wired communication unit 112 is an element for connecting to the communication apparatus 151, the AP 131, and the like over a wire and communicating data, and includes a wired LAN interface. For example, the wired communication unit 112 includes a wired LAN communication unit (a connection unit for a wired LAN cable) for communicating over the wired LAN. The information processing apparatus 101 can connect to the AP 131 through the wired LAN interface using the wired LAN communication unit. The present embodiment assumes that the wired LAN communicates according to the Ethernet standard. The information processing apparatus 101 also includes the Universal Serial Bus (USB) communication unit 113 (a USB cable connection unit (USB port)) for communicating with the communication apparatus 151 over a USB cable. The USB communication unit 113 includes a USB interface. The information processing apparatus 101 can connect to the communication apparatus 151 through the USB interface provided by the USB communication unit 113.

The communication apparatus 151 includes a ROM 152, a RAM 153, a CPU 154, a print engine 155, a wireless communication unit 156, the short-range wireless communication unit 157, an input interface 158, an output interface 159, a function control unit 160, a display unit 161, a wired communication unit 162, a USB communication unit 163, and the like. A computer of the communication apparatus 151 is constituted by the ROM 152, the RAM 153, the CPU 154, and the like. In the present embodiment, initial setting is completed by the communication apparatus 151 accepting an initial setting operation from the user. The communication apparatus 151 becomes capable of performing the various functions provided in the communication apparatus 151 once the initial setting is complete. The initial setting operation for the communication apparatus 151 is an operation performed when the communication apparatus 151 is first powered on (upon arrival). In the present embodiment, the initial setting operations include, for example, removing orange tape from the communication apparatus 151, attaching a print head to the communication apparatus 151, refilling the communication apparatus 151 with a recording material (ink or toner), replacing the paper in the communication apparatus 151, and setting the date and time for the communication apparatus 151. In addition, initial setting processing, which is processing executed by the communication apparatus 151 in accordance with the initial setting operation, includes, for example, processing for cleaning the print head; detecting paper; registration processing, which is processing for adjusting the position where ink lands on the paper in printing (registration adjustment processing); the start of operations in connection setting mode; and the like. The initial setting of the communication apparatus 151 is completed by completing all the initial setting processing.

The wireless communication unit 156 is an element for connecting to the information processing apparatus 101, the AP 131, and the like wirelessly and communicating data, and includes a wireless LAN interface. Although the present embodiment assumes that Wi-Fi, which is a communication method based on the IEEE 802.11 standard, is used as the wireless communication method of the wireless communication unit 156, Bluetooth Classic or the like may be used instead. The AP is capable of connecting to the wireless communication unit 109 of the information processing apparatus 101. Note that the wireless communication unit 156 may communicate directly with the information processing apparatus 101 via an AP 156-a or may communicate with the information processing apparatus 101 via the AP 131. Additionally, the AP 156-a may be hardware that functions as an AP, or the wireless communication unit 156 may operate as an AP 156-a using software for functioning as an AP. The communication apparatus 151 may be capable of internally activating a plurality of APs having different Service Set Identifiers (SSIDs), passwords, and the like. The present embodiment assumes that the AP within the communication apparatus 151 includes at least a connection setting AP (described later).

The RAM 153 is constituted by DRAM or the like that requires a backup power source. Note that the RAM 153 holds data by being supplied with power for data backup (not shown) and can therefore store important data such as program control variables in a non-volatile state. The RAM 153 is also used as a main memory and working memory for the CPU 154, and functions as a reception buffer for temporarily storing print information received from the information processing apparatus 101 to store various types of information.

The ROM 152 stores fixed data such as control programs executed by the CPU 154, data tables, OS programs, and the like. In the present embodiment, the control programs stored in the ROM 152 perform software execution control, such as scheduling, task switching, interrupt processing, and the like, under the management of the embedded OS stored in the ROM 152. A memory area for storing data required to be held even when power is not supplied, such as setting information of the communication apparatus 151, management data of the communication apparatus 151, and the like, is also provided in the ROM 152.

The CPU 154 is a system control unit, and controls the communication apparatus 151 as a whole.

Based on the information stored in the RAM 153 and a print job received from the information processing apparatus 101 or the like, the print engine 155 forms an image on a recording medium such as paper using a recording agent such as ink, and outputs the result of the printing. At this time, the print job transmitted from the information processing apparatus 101 or the like involves transmitting a large amount of data and requires high-speed communication, and is therefore assumed to be received via the wireless communication unit 156, which is capable of faster communication than the short-range wireless communication unit 157.

The short-range wireless communication unit 157 is an element for communicating with devices such as the information processing apparatus 101 using a short-range wireless communication method. Note that BLE, Bluetooth Classic, Wi-Fi Aware, and the like can be given as examples of the communication method of the short-range wireless communication unit 157.

The input interface 158 is an interface capable of accepting data inputs, operational instructions, and the like from a user, and is constituted by a physical keyboard, buttons, a touch panel, or the like. Note that the output interface 159 (described later) and the input interface 158 may be implemented by the same configuration, with that configuration both outputting screens and accepting operations from the user. The output interface 159 is an interface for controlling the display unit 161 to display data, make notifications of the state of the communication apparatus 151, and the like.

The function control unit 160 manages whether to operate each function of the communication apparatus 151.

The display unit 161 is constituted by light-emitting diodes (LEDs), a liquid crystal display (LCD), or the like, and displays data, makes notifications regarding the state of the communication apparatus 151, and the like. Note that inputs from the user can be accepted through the display unit 161 by providing, on the display unit 161, a software keyboard including numerical value input keys, a mode setting key, a confirm key, a cancel key, a power key, and the like.

The wired communication unit 162 is an element for connecting to the information processing apparatus 101, the AP 131, and the like over a wire and communicating data, and includes a wired LAN interface. For example, the wired communication unit 162 includes a wired LAN communication unit (a connection unit for a wired LAN cable) for communicating over the wired LAN. The communication apparatus 151 can connect to the AP 131 through the wired LAN interface using the wired LAN communication unit. The present embodiment assumes that the wired LAN communicates according to the Ethernet standard. The communication apparatus 151 also includes the Universal Serial Bus (USB) communication unit 163 (a USB cable connection unit (USB port)) for communicating with the information processing apparatus 101 over a USB cable. The USB communication unit 163 includes a USB interface. The communication apparatus 151 can connect to the information processing apparatus 101 through the USB interface provided by the USB communication unit 163.

### Direct Connection Method

“Direct connection” refers to a form in which devices connect directly to each other (i.e., peer-to-peer) wirelessly, without going through an external apparatus such as the AP 131 or the like. Direct connection will also be referred to as a “peer-to-peer connection” (“P2P connection”). The communication apparatus 151 can operate in a mode for communicating over a direct connection (a “direct connection mode”) as one connection mode. Wi-Fi communication includes a plurality of modes for communicating over a direct connection, such as a software AP mode, a Wi-Fi Direct (WFD) mode, and the like.

A mode in which a direct connection is made through WFD is called “WFD mode”. WFD is a standard developed by the Wi-Fi Alliance and is included in the IEEE 802.11 series communication standard. In WFD mode, a device to serve as a communication partner is searched for using a device search command, after which the roles of P2P group owner (GO) and P2P client are determined, and the remaining wireless connection processing is performed. “Group owner” corresponds to the parent station (parent device) in Wi-Fi, and the client corresponds to a child station (child device) in Wi-Fi. This role determination corresponds to GO Negotiation in P2P, for example. In WFD mode, the communication apparatus 151 is neither the parent station nor the child station before the roles have been determined. Specifically, one device among the devices that are to communicate issues the device search command, and searches for a device to connect to in WFD mode. When the other device, which is to serve as the communication partner, is discovered, the devices confirm information pertaining to the services and functions those respective devices can supply. Note that the confirmation of the device supply information is optional, and is not required. The device supply information confirmation phase corresponds to Provision Discovery in P2P, for example. Next, which device will serve as the P2P client and which will serve as the P2P group owner is determined by confirming this device supply information with each other. Once the client and the group owner have been determined, the devices exchange parameters for communicating through WFD. The remaining wireless connections and IP connections are processed between the P2P client and group owner based on the exchanged parameters. Note that in WFD mode, the communication apparatus 151 may skip the GO Negotiation described above, and the communication apparatus 151 may always operate as the GO. In other words, the communication apparatus 151 may operate in Autonomous GO mode, which is a WFD mode. A state in which the communication apparatus 151 is operating in WFD mode is a state in which, for example, a connection using WFD is not established but the communication apparatus 151 is operating as the GO, a connection using WFD is established and the communication apparatus 151 is operating as the GO, or the like.

In the software AP mode, among the communicating devices (e.g., the information processing apparatus 101 and the communication apparatus 151), one of the devices (e.g., the information processing apparatus 101) functions as a client that has a role of requesting various types of services. The other device provides a Wi-Fi AP function by configuring software. The software AP corresponds to the parent station in Wi-Fi, and the client corresponds to the child station in Wi-Fi. In software AP mode, the client uses a device search command to search for a device that will serve as a software AP. Once a software AP is discovered, the remaining wireless connection processing (the establishment of a wireless connection and the like) is performed between the client and the software AP, after which IP connection processing (IP address allocation and the like) is performed. Note that commands, parameters, and the like sent and received when establishing a wireless connection between the client and the software AP may be any specified by the Wi-Fi standard, and will therefore not be described here.

In the present embodiment, when establishing and maintaining a direct connection, the communication apparatus 151 operates as the parent station in the network to which the communication apparatus 151 belongs. Note that “parent station” refers to a device that constructs a wireless network, and is a device that provides child stations with the parameters used to connect to the wireless network. The parameters used to connect to the wireless network are parameters pertaining to a channel used by the parent station, for example. By receiving these parameters, a child station connects to the wireless network constructed by the parent station using the channel used by the parent station. In direct connection mode, the communication apparatus 151 operates as the parent station, and the communication apparatus 151 can therefore determine which frequency band and which channel to use in the communication performed in direct connection mode. In the present embodiment, the communication apparatus 151 is assumed to be capable of using a channel corresponding to the 2.4 GHz frequency band and a channel corresponding to the 5 GHz frequency band in the communication performed in direct connection mode. The user can then set the frequency band to be used (i.e., the frequency band channel to be used) as desired by making a setting in a predetermined screen (not shown) displayed by the communication apparatus 151. In other words, if 2.4 GHz is selected on the predetermined screen, the communication apparatus 151 uses a channel corresponding to the 2.4 GHz frequency band in the communication performed in direct connection mode. On the other hand, if 5 GHz is selected on the predetermined screen, the communication apparatus 151 uses a channel corresponding to the 5 GHz frequency band in the communication performed in direct connection mode. However, the present embodiment assumes that even if 5 GHz is selected on the predetermined screen, the communication apparatus 151 will not use a channel corresponding to a Dynamic Frequency Selection (DFS) band in the 5 GHz frequency band for the communication performed in direct connection mode. In other words, the communication apparatus 151 is assumed to use only channels corresponding to frequency bands outside the DFS band in the 5 GHz frequency band for the communication performed in direct connection mode. If, when using a channel corresponding to the DFS band, a radar wave is detected in the frequency band corresponding to that channel, it is necessary to change the channel currently being used. A frequency band in which the channel may be changed in response to a radar wave being detected is called a DFS band. Note, however, that it may be possible to use a channel corresponding to the Dynamic Frequency Selection (DFS) band among the 5 GHz frequency band for communication performed in direct connection mode when, for example, using a wireless chip that supports the DFS function. The channel determined as the channel to be used in the direct connection mode is used in communication over the direct connection. The channel is furthermore used for transmitting a beacon signal as a parent station, transmitting a response to a received command, and the like. In other words, the channel is used not only for communication processing in a direct connection mode in a state where a direct connection is established, but also for communication processing in a direct connection mode in a state where a direct connection is not established.

Although the foregoing describes a configuration in which the user can set whether to use a channel corresponding to the 2.4 GHz frequency band or a channel corresponding to the 5 GHz frequency band in the direct connection mode, the configuration is not limited thereto. The configuration may be such that the user can set a specific channel number to be used in the direct connection mode by accepting a designation of the channel number from the user. The channel used in the direct connection mode may be set in advance in the communication apparatus 151, rather than being set as desired by the user.

Although the foregoing describes a configuration in which the communication apparatus 151 can use the 2.4 GHz frequency band and the 5 GHz frequency band, the configuration is not limited thereto. Other frequency bands may be used, and other frequency bands may be used in the processing in which the 2.4 GHz frequency band or the 5 GHz frequency band are used in the present embodiment. For example, in the IEEE 802.11ad standard, a frequency band of 60 GHz can be used, and thus 60 GHz may be used as the stated other frequency band.

### Infrastructure Connection Method

An “infrastructure connection” is a type of connection for devices that are to communicate (e.g., the information processing apparatus 101 and the communication apparatus 151) to connect to an AP (e.g., the AP 131) handling the network of those devices, and communicate with each other via the AP. The communication apparatus 151 is also capable of operating in a mode for communicating over an infrastructure connection (infrastructure connection mode) as one connection mode.

In an infrastructure connection, each device uses a device search command to search for an AP. Once an AP is discovered, the remaining wireless connection processing (the establishment of a wireless connection and the like) is performed between the device and the AP, after which IP connection processing (the allocation of IP addresses and the like) is performed. Note that commands, parameters, and the like sent and received when establishing a wireless connection between the devices and the AP may be any specified by the Wi-Fi standard, and will therefore not be described here.

In the present embodiment, when the communication apparatus 151 operates over an infrastructure connection, the AP 131 operates as the parent station and the communication apparatus 151 operates as a child station. In other words, in the present embodiment, “infrastructure connection” refers to a connection between the communication apparatus 151, which operates as a child station, and a device operating as a parent station. When the communication apparatus 151 has established an infrastructure connection and the information processing apparatus 101 has also established an infrastructure connection with the AP 131, the communication apparatus 151 and the information processing apparatus 101 can communicate via the AP 131. The channel used for communication in the infrastructure connection is determined by the AP 131, and thus the communication apparatus 151 communicates over the infrastructure connection using the channel determined by the AP 131. In the present embodiment, the communication apparatus 151 is assumed to be capable of using a channel corresponding to the 2.4 GHz frequency band and a channel corresponding to the 5 GHz frequency band in the communication performed in the infrastructure connection. Note that the communication apparatus 151 can also use a channel corresponding to the DFS band within the 5 GHz frequency band in the communication performed in the infrastructure connection. Note also that to communicate via the communication apparatus 151 and the AP 131, the information processing apparatus 101 recognizes and specifies the communication apparatus 151 as belonging to the network that is formed by the AP 131 and to which the information processing apparatus 101 belongs.

### Connection Setting Mode

The communication apparatus 151 can operate in a connection setting mode. The trigger for the communication apparatus 151 to start operating in the connection setting mode may be, for example, a user pressing a connection setting mode button, or the communication apparatus 151 being started (powered on) for the first time after being shipped. The connection setting mode button may be a physical button included in the communication apparatus 151, or may be a software button displayed on the display unit 161 by the communication apparatus 151.

When the communication apparatus 151 starts operating in the connection setting mode, both Wi-Fi communication and BLE communication are enabled. Specifically, the communication apparatus 151 enables an internal AP of the communication apparatus 151 (a connection setting AP), which is specifically for the connection setting mode, as processing for enabling Wi-Fi communication. This enables the communication apparatus 151 to establish a direct connection with the information processing apparatus 101 using Wi-Fi. Connection information (an SSID, a password, or the like) for connecting to the connection setting AP is held in advance in a predetermined app (e.g., a setup app) installed in the information processing apparatus 101. In other words, it is assumed that the information processing apparatus 101 has recognized the connection information for connecting to the connection setting AP in advance. Accordingly, unlike the connection information of the AP enabled in the direct connection mode, it is assumed that the connection information for connecting to the connection setting AP cannot be changed by the user as desired. When the communication apparatus 151 operating in the connection setting mode and the information processing apparatus 101 are connected, the information processing apparatus 101 transmits, through the setup app, a setting command for setting the connection mode of the communication apparatus 151 to the communication apparatus 151. The setting command is, for example, a command for causing the communication apparatus 151 to operate in the infrastructure connection mode, and more specifically, is information including connection information (an SSID, a password, or the like) for connecting to the AP 131, for example. Note that in the connection setting mode, the communication apparatus 151 may connect to the information processing apparatus 101 using Wi-Fi Direct (WFD) instead of normal Wi-Fi. In other words, the communication apparatus 151 may operate as the Group Owner and receive setting commands from the information processing apparatus 101 through communication using WFD.

### Wireless Profile

A “wireless profile” is information stored and managed by the OS of the information processing apparatus 101, and is information including connection information of APs to which the information processing apparatus 101 has been connected in the past. The wireless profile is used for a reconnection function in which, for example, when a connection between the information processing apparatus 101 and an AP is cut off, the OS automatically re-establishes the connection.

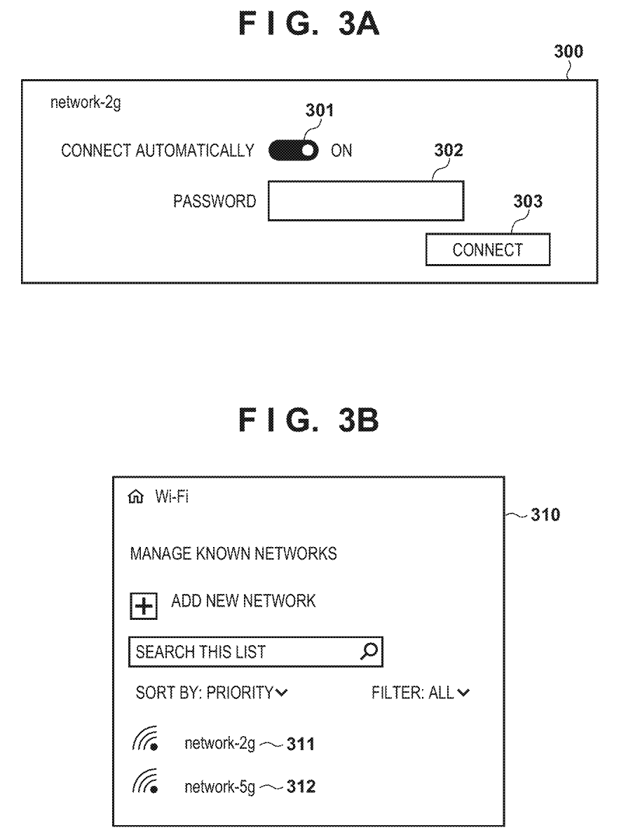

FIG. 3A illustrates an example of a connection screen, displayed by the OS, for the information processing apparatus 101 to connect to an AP. A connection screen 300 is a screen for connecting to the AP 131 having an SSID displayed on the connection screen 300. The connection screen 300 includes a toggle button 301 for setting whether to enable the reconnection function in the connection with the AP 131, an input box 302 for accepting an input of a password for connecting to the AP 131, and a “connect” button 303 for attempting to establish a connection between the AP 131 and the information processing apparatus 101 using the password that has been input. When the reconnection function is enabled using the toggle button 301, if the connection between the information processing apparatus 101 and the AP 131 is cut off, the OS automatically re-establishes the connection. On the other hand, when the reconnection function is disabled using the toggle button 301, even if the connection between the information processing apparatus 101 and the AP 131 is cut off, the OS does not automatically re-establish the connection. When the connection between the AP 131 and the information processing apparatus 101 is successfully established as a result of the “connect” button 303 being pressed, the OS saves the connection information (the SSID, the password, and the like) of the AP 131 as a wireless profile. However, in specific types of OSs and specific versions of OSs, when the reconnection function is disabled, the connection information of the AP 131 is not saved as a wireless profile even if the connection between the AP 131 and the information processing apparatus 101 is successfully established.

FIG. 3B illustrates an example of a wireless profile screen, which is a screen displayed by the OS for indicating stored wireless profiles. A wireless profile screen 310 is an example of a screen displayed when the OS stores two wireless profiles. Wireless profiles having higher priorities are displayed higher in the wireless profile screen 310. A high-priority wireless profile is a wireless profile that is used with higher priority in a state where a connection between the information processing apparatus 101 and the AP is not established. A region 311 is a region where the first wireless profile having a higher priority is indicated by the SSID, and a region 312 is a region where the second wireless profile having a lower priority is indicated by the SSID. Note that performing a predetermined operation on the region 311, the region 312, or the like makes it possible to delete the wireless profile corresponding to the region where the predetermined operation was performed from the information processing apparatus 101.

### Processing Performed by Information Processing Apparatus 101 and Communication Apparatus 151

In the present embodiment, the setup app can execute network setup for the communication apparatus 151 over the wireless connection between the information processing apparatus 101 and the communication apparatus 151 operating in the connection setting mode (“first setup” hereinafter). In other words, the first setup is a setup method for connecting the communication apparatus 151 and the AP by having the setup app transmit setting information from the information processing apparatus 101 to the communication apparatus 151 through wireless communication. Note that the setting information includes a password for connecting to the AP. At this time, if the wireless profile corresponding to a predetermined AP that is the connection partner of the communication apparatus 151 is already saved in the information processing apparatus 101 prior to the setup app accepting a predetermined operation for network setup (a predetermined instruction) from a user, the setup app can execute the first setup without accepting the input of a password from the user.

Additionally, in the present embodiment, the communication apparatus 151 can connect to the AP through a method other than the first setup. Second setup and third setup, which are methods aside from the first setup, are instances of network setup performed without the setup app transmitting setting information from the information processing apparatus 101 to the communication apparatus 151 through wireless communication. Specifically, for example, the second setup is network setup using push-button Wi-Fi Protected Setup (WPS). Note that the second setup may be network setup using PIN code-based WPS. The second setup may also be network setup other than WPS, such as AOSS, Easy Wireless Start, or the like. Additionally, the second setup may be network setup performed by establishing a connection between an AP, among APs discovered by the communication apparatus 151, that has been selected by the user in an operation performed on the communication apparatus 151, and the communication apparatus 151, over a wireless LAN. The third setup, which is a method other than the first and second setup, is network setup performed by establishing a connection between the AP and the communication apparatus 151 over a wired LAN. Additionally, fourth setup, which is a method other than the first, second, and third setup, is a setup method performed by establishing a USB connection between the information processing apparatus 101 and the communication apparatus 151. The fourth setup can be executed when no network for connecting the communication apparatus 151 is available nearby. Note that the fourth setup may be performed by establishing a Bluetooth connection between the information processing apparatus 101 and the communication apparatus 151.

As described above, the first setup to the fourth setup are methods for establishing a connection between the information processing apparatus 101 and the communication apparatus 151. When one of the first setup to the third setup is executed between the information processing apparatus 101 and the communication apparatus 151, a connection is established between the information processing apparatus 101 and the communication apparatus 151 via the AP. In other words, the communication apparatus 151 can be connected to a network formed by the AP. Connecting the communication apparatus 151 to the network makes it possible to connect a plurality of information processing apparatuses 101 to the communication apparatus 151, use Internet-based services, and the like.

On the other hand, when the fourth setup is executed between the information processing apparatus 101 and the communication apparatus 151, a USB connection is established between the information processing apparatus 101 and the communication apparatus 151 without going through the AP, for example. In such a case, the communication apparatus 151 is not connected to the network formed by the AP, and thus a plurality of information processing apparatuses 101 cannot be connected to the communication apparatus 151, and Internet-based services cannot be used. Note that this does not necessarily apply when the communication apparatus 151 has established a connection with the AP different from a USB connection between the information processing apparatus 101 and the communication apparatus 151.

Incidentally, even when the information processing apparatus 101 is connected to the communication apparatus 151 by USB, some users may wish to connect a plurality of information processing apparatuses 101 to the communication apparatus 151, use Internet-based services, and the like. However, when the information processing apparatus 101 is connected to the communication apparatus 151 by USB, the user may not be able to recognize that there is a connection form between the information processing apparatus 101 and the communication apparatus 151 different from the USB connection. There has thus been room for improvement in terms of usability when connecting the communication apparatus 151 to the information processing apparatus 101.

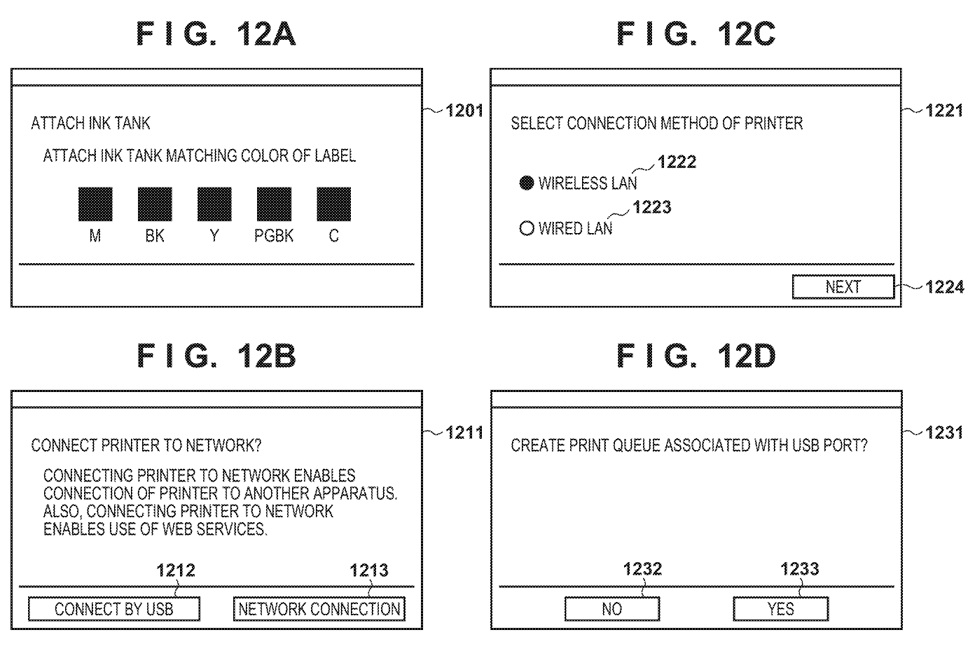

Accordingly, in the present embodiment, the setup app causes the CPU 103 to execute processing such as that described below. Upon detecting the communication apparatus 151 connected to the information processing apparatus 101 only through the USB interface, the CPU 103 displays a network connection guidance screen 1211 (described later; see FIG. 12B) on the display unit 108. The guidance screen 1211 is a screen for accepting the designation of an external interface to be used for the connection between the information processing apparatus 101 and the communication apparatus 151. This screen display makes it possible to ensure the user recognizes that another external interface can be used when the information processing apparatus 101 is connected to the communication apparatus 151 by USB. In other words, the usability when connecting the communication apparatus 151 to the information processing apparatus 101 can be improved.

Among communication apparatuses 151, some specific models exist in which when a USB connection is established between the information processing apparatus 101 and the communication apparatus 151 during the connection setting mode, the connection setting mode is terminated. In addition, for a communication apparatus 151 of such a specific model to operate in the connection setting mode again to perform the first setup, it is necessary to accept an operation for operating in the connection setting mode. This operation includes, for example, pressing a specific button provided in the communication apparatus 151, operating a specific menu on a screen displayed by the communication apparatus 151, and the like. In addition, for a communication apparatus 151 of a specific model to accept an operation for operating in the connection setting mode, it is necessary to complete the initial setting by accepting an initial setting operation from the user. In other words, unless the initial setting is completed, the communication apparatus 151 of the specific model cannot accept an operation for operating in the connection setting mode. Or, unless the initial setting is completed, the communication apparatus 151 of the specific model cannot operate in the connection setting mode or the like based on accepting an operation for operating in the connection setting mode. The present embodiment assumes that the communication apparatus 151 to be set up is such a specific model. Accordingly, if the communication apparatus 151 to be set up is connected to the information processing apparatus 101 only through the USB interface, it is necessary for the communication apparatus 151 to complete the initial setting in order for the information processing apparatus 101 and the communication apparatus 151 to complete the first setup.

Accordingly, in the present embodiment, the setup app causes the CPU 103 to execute processing such as that described below. Upon detecting the communication apparatus 151 connected to the information processing apparatus 101 only through the USB interface, the CPU 103 obtains information indicating whether the initial setting of the communication apparatus 151 is complete. The CPU 103 then displays the guidance screen 1211 based on the obtained information being information indicating that the initial setting of the communication apparatus 151 is complete. On the other hand, if the initial setting of the communication apparatus 151 is not complete, the CPU 103 makes a notification indicating a procedure for the initial setting operation. Such a configuration makes it possible to display the guidance screen 1211 in a state where the communication apparatus 151 to be set up can operate in the connection setting mode, even if the communication apparatus 151 is a specific model.

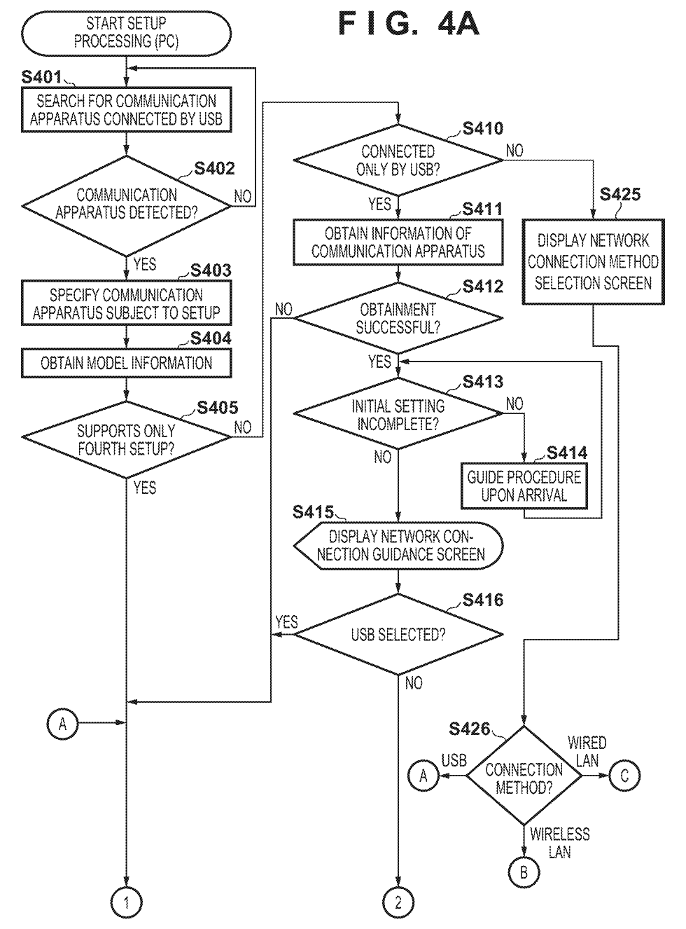

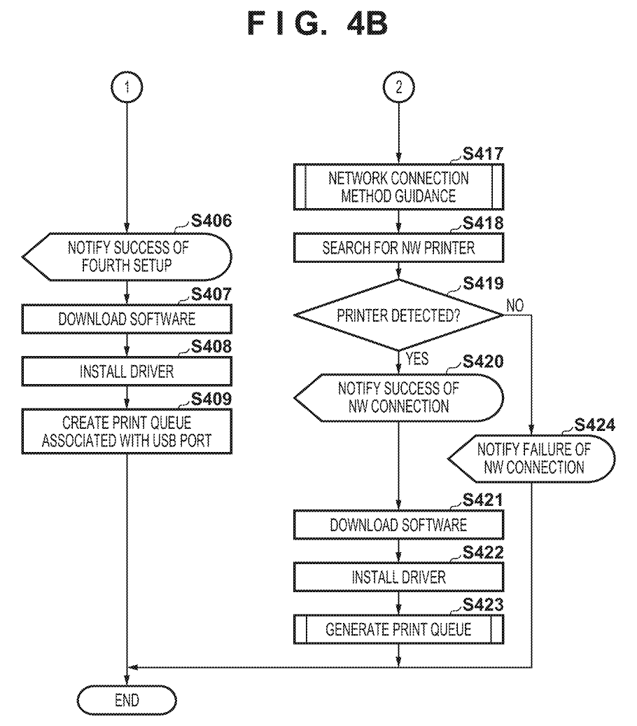

FIGS. 4A and 4B are flowcharts illustrating an example of processing, executed by the information processing apparatus 101 according to the present embodiment, for making the communication apparatus 151 usable from the information processing apparatus 101 (called “setup processing” hereinafter). This flowchart is implemented, for example, by the CPU 103 reading out a program stored in the ROM 104 into the RAM 105 and executing the program. The CPU 103 starts the processing illustrated in FIGS. 4A and 4B based on a user operation for executing the setup app made through the input interface 102 of the information processing apparatus 101.

In step S401, the CPU 103 searches for the communication apparatus 151. Specifically, the CPU 103 obtains information about the communication apparatus 151 connected to the information processing apparatus 101 from the OS of the information processing apparatus 101 using an Application Program Interface (API) of the OS. Then, one or more communication apparatuses indicated by this information are detected and identified as communication apparatuses 151 that are candidates for the setup processing. This information is assumed to include information indicating communication apparatuses 151 discovered through a search performed by the information processing apparatus 101 using the wireless communication unit 109, information indicating communication apparatuses 151 discovered through a search performed by the information processing apparatus 101 using the wired communication unit 112, and information indicating communication apparatuses 151 discovered through a search performed by the information processing apparatus 101 using the USB communication unit 113. In other words, a communication apparatus 151 discovered through the search performed by the information processing apparatus 101 using the wireless communication unit 109 is a communication apparatus 151 connected to the information processing apparatus 101 through the wireless LAN interface. To rephrase, this is a communication apparatus 151 belonging to the network to which the information processing apparatus 101 is connected through the wireless LAN interface. The search performed using the wireless communication unit 109 is performed by broadcasting or multicasting on the network to which the information processing apparatus 101 is connected through the wireless LAN interface, for example. In other words, a communication apparatus 151 discovered through the search performed by the information processing apparatus 101 using the wired communication unit 112 is a communication apparatus 151 connected to the information processing apparatus 101 through the wired LAN interface. A communication apparatus 151 discovered through the search performed by the information processing apparatus 101 using the USB communication unit 113 is, in other words, a communication apparatus 151 connected to the information processing apparatus 101 through the USB interface. In the following descriptions, a communication apparatus 151 connected to the information processing apparatus 101 through the USB interface may be called a “USB-connected communication apparatus 151”. In this processing, the CPU 103 may further search for a communication apparatus 151 operating in the connection setting mode. Specifically, for example, the CPU 103 may search for a beacon including a predetermined SSID issued by a communication apparatus 151 operating in the connection setting mode (called a “connection setting SSID” hereinafter) using the wireless communication unit 109. In this manner, a plurality of searches may be performed in this processing. It is assumed that through this, a communication apparatus 151A may be discovered through a first search among the plurality of searches, and a communication apparatus 151B, which is a communication apparatus 151 different from the communication apparatus 151A, may be discovered through a second search, different from the first search, among the plurality of searches, for example. Assume also that the same communication apparatus 151A may be discovered in both the first search and the second search.

In step S402, the CPU 103 determines whether the USB-connected communication apparatus 151 has been detected. If the CPU 103 determines that the USB-connected communication apparatus 151 has not been detected, the processing from step S401 is repeated. However, if the CPU 103 determines that the USB-connected communication apparatus 151 has been detected, the sequence moves to step S403. Note that the CPU 103 may execute processing different from that described above if the USB-connected communication apparatus 151 is determined not to have been detected. Specifically, if, for example, the USB-connected communication apparatus 151 has not been detected, but a communication apparatus 151 discovered through the search performed using the wireless communication unit 109 has been detected, the CPU 103 may move the sequence to step S402. If the USB-connected communication apparatus 151 has not been detected, but a communication apparatus 151 discovered through the search performed using the wired communication unit 112 has been detected, the CPU 103 may end the processing of this flowchart. If the USB-connected communication apparatus 151 has not been detected, but a communication apparatus 151 operating in the connection setting mode has been detected, the CPU 103 may move the sequence to step S510. If the USB-connected communication apparatus 151 has been detected, and a communication apparatus 151 operating in the connection setting mode has been detected, the CPU 103 may move the sequence to step S510 to prioritize the connection setting processing for the communication apparatus 151 operating in the connection setting mode.

In step S403, the CPU 103 specifies the detected USB-connected communication apparatus 151 as the communication apparatus 151 subject to the setup processing. Note that a plurality of USB-connected communication apparatuses 151 may be detected as a result of the processing of step S401. In that case, the CPU 103 may display a list of the detected plurality of USB-connected communication apparatuses 151 and specify a communication apparatus 151 selected from the list by the user as the communication apparatus 151 subject to the setup processing. The CPU 103 may also specify the communication apparatus 151 detected first among the detected plurality of USB-connected communication apparatuses 151 as the communication apparatus 151 subject to the setup processing.

In step S404, based on a model name of the communication apparatus 151 specified as the subject of the setup processing in step S403, the CPU 103 obtains (downloads) a model information file containing model information of the communication apparatus 151 from the external server 171. Note that the configuration may be such that the CPU 103 obtains the model information file from the communication apparatus 151 through the USB interface.

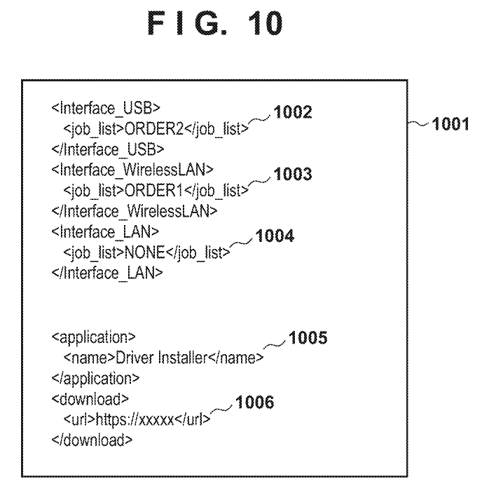

FIG. 10 illustrates an example of a model information file 1001 obtained in step S404. The model information file 1001 includes information pertaining to connection forms supported by the communication apparatus 151 and information about the software used by the communication apparatus 151.

Specifically, the information pertaining to the connection forms supported by the communication apparatus 151 includes information indicating the types of external interfaces supported by the communication apparatus 151 and a priority order of the connection forms of the communication apparatus 151. In the example in FIG. 10, connection information 1002 to 1004 is included as the information pertaining to the connection forms supported by the communication apparatus 151. “ORDER2” written as the connection information 1002 indicates that the communication apparatus 151 supports the USB interface and that the USB connection form is second in priority in the communication apparatus 151. “ORDER1” written as the connection information 1003 indicates that the communication apparatus 151 supports the wireless LAN interface and that the wireless LAN connection form is first in priority in the communication apparatus 151. “NONE” written as the connection information 1004 indicates that the communication apparatus 151 does not support the wired LAN interface. In other words, the connection information 1004 indicates that the communication apparatus 151 does not support wired LAN connections.

The information about the software supported by the communication apparatus 151 includes a name 1005 of the software and a download URL 1006. The name 1005 of the software is information indicating the name of each item of software, such as a driver installer used by the communication apparatus 151. The download URL 1006 is information indicating a URL for downloading the software indicated by the name 1005 of the software.

In step S405, based on the information pertaining to the connection forms supported by the communication apparatus 151 obtained in step S404, the CPU 103 determines whether the model of the communication apparatus 151 is a model that supports only the fourth setup. Specifically, the CPU 103 refers to the connection information 1002 to 1004 written in the model information file 1001 and determines whether the communication apparatus 151 only supports USB connections. In other words, step S405 is processing for determining whether the only external interface supported by the communication apparatus 151 is the USB interface. If the CPU 103 determines that the communication apparatus 151 is a model that supports only the fourth setup (the communication apparatus 151 is a model that supports only the USB interface), the sequence moves to step S406. However, if the CPU 103 determines that the communication apparatus 151 is not a model that supports only the fourth setup (that the communication apparatus 151 is a model that also supports an external interface different from the USB interface), the sequence moves to step S410.

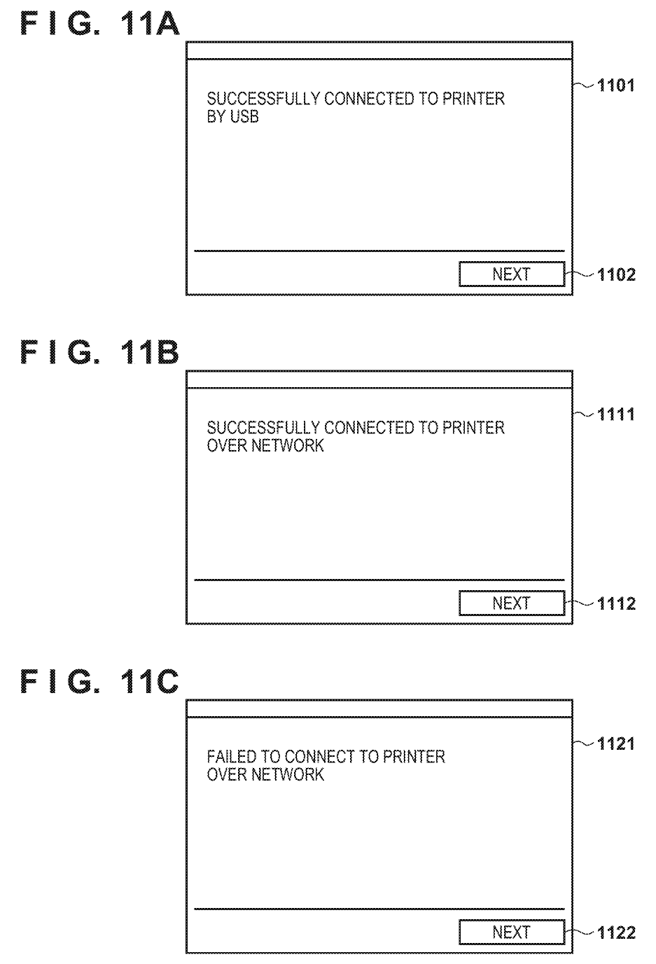

In step S406, the CPU 103 displays a fourth setup success screen 1101, illustrated in FIG. 11A, on the display unit 108. The fourth setup success screen 1101 displays a message indicating that the information processing apparatus 101 has successfully established a USB connection with the communication apparatus 151 subject to the setup. In other words, step S406 is processing for notifying the user that the communication apparatus 151 has been connected to the information processing apparatus 101 through the USB interface. The fourth setup success screen 1101 also includes a “next” button 1102. When the “next” button 1102 is pressed, the CPU 103 moves the sequence to step S407. Note that the configuration is not limited to one in which the fourth setup success screen 1101 is displayed, and the CPU 103 may proceed with the processing after communicating the stated message by audio using a speaker (not shown) provided in the information processing apparatus 101.

In step S407, the CPU 103 refers to the download URL 1006 of each item of software included in the model information file 1001 obtained in step S404, and downloads each item of software, including a driver installer.

In step S408, the CPU 103 executes the driver installer downloaded in step S407, and installs the driver of the communication apparatus 151.

In step S409, the CPU 103 generates a print queue associated with the USB port on which the communication apparatus 151 has been detected in step S402, and ends the setup processing illustrated in FIGS. 4A and 4B. When step S409 is executed and the setup processing illustrated in FIGS. 4A and 4B ends, the information processing apparatus 101 can transmit image data and print instructions to the communication apparatus 151 connected to the information processing apparatus 101 by USB, through the print queue generated in step S409.

In step S410, the CPU 103 determines whether the communication apparatus 151 specified in step S403 is a communication apparatus 151 detected (discovered) only through the search performed through the USB interface in step S401. If the CPU 103 determines that the communication apparatus 151 specified in step S403 is a communication apparatus 151 detected only through the search performed through the USB interface, the sequence moves to step S411. On the other hand, if the CPU 103 determines that the communication apparatus 151 specified in step S403 is not a communication apparatus 151 discovered only through the search performed through the USB interface, the sequence moves to step S425. In other words, if the communication apparatus 151 specified in step S403 is a communication apparatus 151 detected through the search performed through the USB interface in step S401, and is a communication apparatus 151 not detected through a search performed through an external interface other than the USB interface, a determination of “YES” is made in step S411. On the other hand, if the communication apparatus 151 specified in step S403 is a communication apparatus 151 detected through both the search performed through the USB interface and a search performed through an external interface other than the USB interface in step S401, a determination of “NO” is made in step S411. A “search performed through an external interface other than the USB interface” is a search performed by the information processing apparatus 101 using the wireless communication unit 109 and a search performed by the information processing apparatus 101 using the wired communication unit 112.

In step S411, the CPU 103 obtains information about the communication apparatus 151 from the communication apparatus 151 through the USB interface. The information about the communication apparatus 151 obtained in step S411 includes information indicating whether the initial setting of the communication apparatus 151 is complete. For example, if the initial setting of the communication apparatus 151 is incomplete, the CPU 103 obtains information indicating that the initial setting is incomplete as the information about the communication apparatus 151. On the other hand, for example, if the initial setting of the communication apparatus 151 is complete, the CPU 103 obtains information indicating that the initial setting is complete as the information about the communication apparatus 151.

In step S412, the CPU 103 determines whether the information about the communication apparatus 151 has been obtained in step S411. If the CPU 103 determines that the information about the communication apparatus 151 has been obtained, the sequence moves to step S413. However, if the CPU 103 determines that the information about the communication apparatus 151 has not been successfully obtained, the processing of steps S406 to S409 is executed, after which the setup processing illustrated in FIGS. 4A and 4B ends.

In step S413, the CPU 103 determines whether the initial setting of the communication apparatus 151 is incomplete based on the information about the communication apparatus 151 obtained in step S411. If the CPU 103 determines that the initial setting of the communication apparatus 151 is incomplete, the sequence moves to step S414. However, if the CPU 103 determines that the initial setting of the communication apparatus 151 is complete, the sequence moves to step S415.

In step S414, the CPU 103 displays an initial setting operation guidance screen 1201, illustrated in FIG. 12A, on the display unit 108. As described later, in the present embodiment, the processing for the first setup executed in step S417 may be executed as the processing executed after the communication apparatus 151 is discovered through the search performed through the USB interface. Although it is necessary for the communication apparatus 151 to operate in the connection setting mode for the first setup, the communication apparatus 151 stops operating in the connection setting mode when a USB connection is detected, as described above. In order for the communication apparatus 151 to resume operating in the connection setting mode, it is necessary to complete the initial setting. Accordingly, in the present embodiment, if the initial setting of the communication apparatus 151 is incomplete, the CPU 103 executes the processing of step S414 as processing for completing the initial setting. The guidance screen 1201 displays a message prompting the user to attach a consumable used in the communication apparatus 151 to the communication apparatus 151 as the initial setting operation. The example in FIG. 12A illustrates an ink cartridge as the consumable used in the communication apparatus 151. In other words, step S414 is processing for notifying the user of a procedure for completing the initial setting. Note that the display content of the guidance screen 1201 is not limited to the example illustrated in FIG. 12A. For example, the guidance screen 1201 may display a message prompting the user to place a recording medium such as a sheet or the like, which is a consumable used in the communication apparatus 151, in the communication apparatus 151. Additionally, for example, a message for guiding the user through various procedures as the initial setting operation, such as a procedure for test printing in the communication apparatus 151, making communication settings in the communication apparatus 151, and the like, may be displayed in the guidance screen 1201. In other words, the guidance screen 1201 may be a screen for guiding operation procedures for each of operations included in the initial setting operations described above. Additionally, the guidance screen 1201 may include a button (not shown) for displaying a manual containing detailed descriptions of the initial setting operations. The configuration may be such that when the button (not shown) is pressed, the CPU 103 displays a page of a web-based manual on the display unit 108 as Internet content, using a web browser or the like. Additionally, the configuration is not limited to one in which the guidance screen 1201 is displayed, and the CPU 103 may proceed with the processing after communicating a procedure for completing the initial setting by audio using a speaker (not shown) provided in the information processing apparatus 101. After step S414, the CPU 103 re-obtains the information about the communication apparatus 151 from the communication apparatus 151 through the USB interface and repeats the processing from step S413.

In step S415, the CPU 103 displays the network connection guidance screen 1211 illustrated in FIG. 12B on the display unit 108. The guidance screen 1211 includes a “connect by USB” button 1212 and a “connect over network” button 1213. The “connect by USB” button 1212 is a button capable of accepting the designation of the USB interface as the external interface used to connect the communication apparatus 151 to the information processing apparatus 101. The “connect over network” button 1213 is a button capable of accepting the designation of an external interface different from the USB interface as the external interface used to connect the communication apparatus 151 to the information processing apparatus 101. When the user presses one of the buttons, the CPU 103 moves the sequence to step S416. In other words, the guidance screen 1211 can also be said to be a screen for accepting the designation of the external interface used to connect the communication apparatus 151 to the information processing apparatus 101. In this manner, the guidance screen 1211 is displayed on the display unit 108, even when the communication apparatus 151 is connected to the information processing apparatus 101 by USB. This enables the user to recognize that the communication apparatus 151 can be connected to the information processing apparatus 101 through another external interface. Accordingly, the usability when connecting the communication apparatus 151 to the information processing apparatus 101 can be improved.

The guidance screen 1211 also displays a message prompting the user to connect the communication apparatus 151 to the network. This message can also be said to prompt the user to designate a type of external interface different from that of the USB interface. Displaying such a message on the guidance screen 1211 makes it possible to prompt the user to connect the communication apparatus 151 to the information processing apparatus 101 through another external interface even when the communication apparatus 151 is connected to the information processing apparatus 101 by USB.

The guidance screen 1211 also displays a message explaining the benefits of connecting the communication apparatus 151 to the network. In this example, a message indicating that connecting the communication apparatus 151 to the network will enable the communication apparatus 151 to connect to other information processing apparatuses 101 as well, a message indicating that connecting the communication apparatus 151 to the network will enable web services to be used, or the like is displayed. In other words, the guidance screen 1211 displays such benefits of a case where an external interface of a type different from that of the USB interface is designated. Displaying such a message makes it possible for the user to recognize the benefits of connecting the information processing apparatus 101 and the communication apparatus 151 using another external interface.

In step S416, the CPU 103 determines whether the button selected by the user in step S415 is the “connect by USB” button 1212. If the CPU 103 determines that the button selected by the user in step S415 is the “connect by USB” button 1212, the processing in steps S406 to S409 is executed, after which the setup processing illustrated in FIGS. 4A and 4B ends. However, if the CPU 103 determines that the button selected by the user in step S415 is not the “connect by USB” button 1212, the sequence moves to step S417. In other words, if the button selected by the user in step S415 is the “connect over network” button 1213, the sequence moves to step S417.

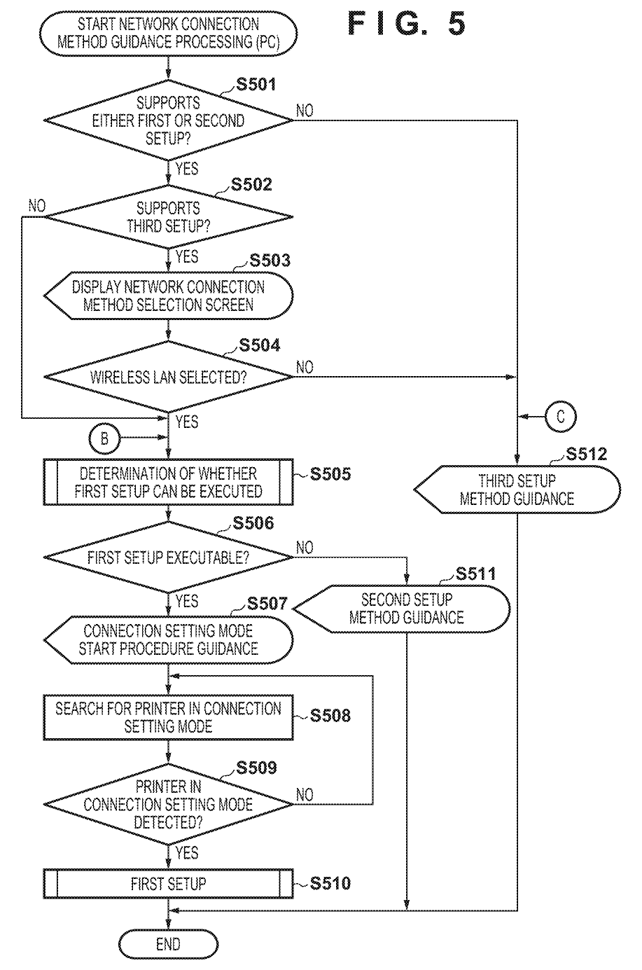

In step S417, the CPU 103 executes predetermined processing for connecting the communication apparatus 151 to the information processing apparatus 101 through an external interface of a type different from the USB interface. Specifically, the external interface of a type different from that of the USB interface is the wireless LAN interface, the wired LAN interface, or the like. The predetermined processing is processing for guiding the user through a method for establishing a network connection between the communication apparatus 151 and an AP (called “network connection method guidance processing” hereinafter). In the present embodiment, the CPU 103 executes at least one of wireless LAN guidance processing and wired LAN guidance processing as the network connection method guidance processing of step S417. The wireless LAN guidance processing is processing for connecting the communication apparatus 151 to the information processing apparatus 101 through the wireless LAN interface. The wireless LAN guidance processing includes the first setup and the second setup. The wired LAN guidance processing is processing for connecting the communication apparatus 151 to the information processing apparatus 101 through the wired LAN interface. The wired LAN guidance processing includes the third setup. The network connection method guidance processing of step S417 will be described later in detail with reference to FIG. 5.

In step S418, the CPU 103 searches for communication apparatuses 151 on the network, formed by the AP, to which the information processing apparatus 101 belongs. This search is performed using the wireless LAN interface and the wired LAN interface. The configuration may be such that the wireless LAN interface is used when the wireless LAN connection form is selected in FIG. 5, and the wired LAN interface is used when the wired LAN connection form is selected in FIG. 5. By executing one of the first setup, the second setup, and the third setup, the communication apparatus 151 is discovered through this search if the information processing apparatus 101 and the communication apparatus 151 are connected to the same AP.

In step S419, the CPU 103 determines whether the communication apparatus 151 has been detected (discovered) through the search performed in step S418. If the CPU 103 determines that the communication apparatus 151 has been detected, the sequence moves to step S420. However, if the CPU 103 determines that the communication apparatus 151 has not been detected, the sequence moves to step S424.

In step S420, the CPU 103 displays a network connection success screen 1111, illustrated in FIG. 11B, on the display unit 108. The network connection success screen 1111 displays a message indicating that a network connection between the communication apparatus 151 and the AP 131 has been successfully established. In other words, step S420 is processing for notifying the user that a network connection between the communication apparatus 151 and the AP 131 has been successfully established. The network connection success screen 1111 includes a “next” button 1112. When the “next” button 1112 is pressed, the CPU 103 moves the sequence to step S421. Note that the configuration is not limited to one in which the network connection success screen 1111 is displayed, and the CPU 103 may proceed with the processing after communicating the stated message by audio using a speaker (not shown) provided in the information processing apparatus 101.

The processing of steps S421 to S422 is the same as that of steps S407 to S408, and will therefore not be described here.

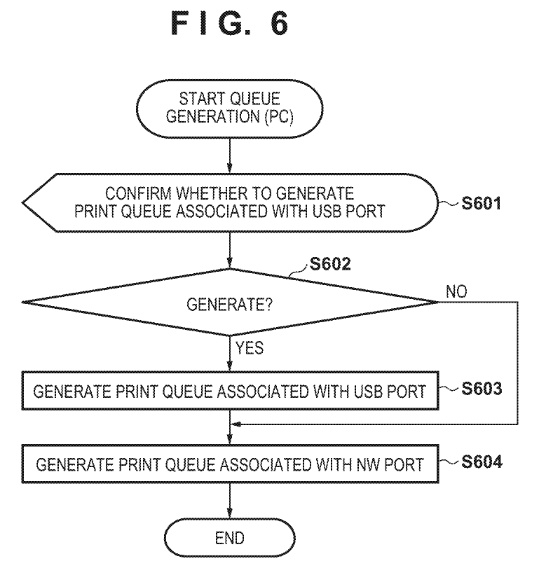

In step S423, the CPU 103 executes print queue generation processing, and ends the setup processing illustrated in FIGS. 4A and 4B. The print queue generation processing will be described later with reference to FIG. 6.

In step S424, the CPU 103 displays a network connection failure screen 1121, illustrated in FIG. 11C, on the display unit 108. The network connection failure screen 1121 displays a message indicating that the communication apparatus 151 could not be detected, a message indicating that the connection with the communication apparatus 151 has failed, or the like. In other words, step S424 is processing for notifying the user that a network connection between the communication apparatus 151 and the AP 131 has failed. When an “end” button 1122 included in the network connection failure screen 1121 is pressed, the CPU 103 ends the setup processing illustrated in FIGS. 4A and 4B. Note that the configuration is not limited to one in which the network connection failure screen 1121 is displayed, and the CPU 103 may proceed with the processing after communicating the stated message by audio using a speaker (not shown) provided in the information processing apparatus 101.

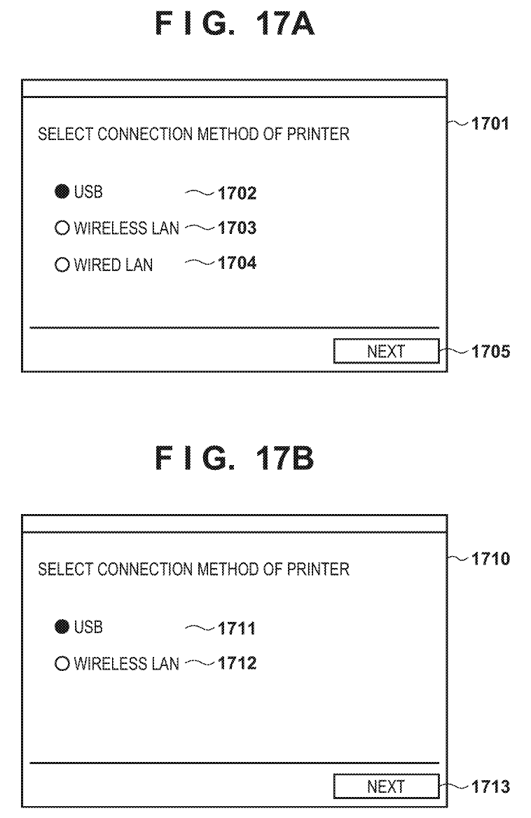

In step S425, the CPU 103 displays a network connection method selection screen based on the model information file obtained in step S404. Specifically, in step S425, if the model information obtained in step S404 includes connection information indicating that the communication apparatus 151 supports the wired LAN interface, the CPU 103 displays a selection screen 1701, illustrated in FIG. 17A. The selection screen 1701 includes a region 1702 capable of accepting a selection of the USB connection form, a region 1703 capable of accepting a selection of the wireless LAN connection form, a region 1704 capable of accepting a selection of the wired LAN connection form, and a “next” button 1705. When the “next” button 1705 is pressed, the CPU 103 moves the sequence to step S426. On the other hand, if, in step S425, the model information obtained in step S404 does not include connection information indicating that the communication apparatus 151 supports the wired LAN interface, the CPU 103 displays a selection screen 1710, illustrated in FIG. 17B. The selection screen 1710 includes a region 1711 capable of accepting a selection of the USB connection form, a region 1712 capable of accepting a selection of the wireless LAN connection form, and a “next” button 1713. When the “next” button 1713 is pressed, the CPU 103 moves the sequence to step S426. In this manner, in step S425, the CPU 103 displays a selection screen according to whether the model information file obtained in step S404 includes connection information indicating that the communication apparatus 151 supports the wired LAN interface.

In step S426, the CPU 103 determines a user operation made on the selection screen displayed in step S425. If the selection of the USB connection form is accepted in the selection screen displayed in step S425, the CPU 103 moves the sequence to step S406. If the selection of the wireless LAN connection form is accepted in the selection screen displayed in step S425, the CPU 103 moves the sequence to step S505 (described later). Furthermore, if the selection of the wired LAN connection form is accepted in the selection screen displayed in step S425, the CPU 103 moves the sequence to step S512 (described later).

FIG. 5 is a flowchart illustrating an example of the network connection method guidance processing executed by the information processing apparatus 101. This flowchart is implemented, for example, by the CPU 103 reading out a program stored in the ROM 104 into the RAM 105 and executing the program. The processing illustrated in this flowchart corresponds to the processing performed in step S417.

In step S501, based on the information pertaining to the connection forms supported by the communication apparatus 151 obtained in step S404, the CPU 103 determines whether the communication apparatus 151 is a model that supports at least one of the first setup and the second setup. If the CPU 103 determines that the communication apparatus 151 is a model that supports either the first setup or the second setup, the sequence moves to step S502. However, if the CPU 103 determines that the communication apparatus 151 is a model that supports neither the first setup nor the second setup, the sequence moves to step S512. Specifically, the CPU 103 refers to the wireless connection information 1003 written in the model information file 1001 and determines whether the communication apparatus 151 supports the wireless LAN interface. If the connection information 1003 is information indicating that the communication apparatus 151 supports the wireless LAN interface, the CPU 103 determines that the communication apparatus 151 supports the wireless LAN interface, and the sequence moves to step S502. However, if the connection information 1003 is information indicating that the communication apparatus 151 does not support the wireless LAN interface, the CPU 103 determines that the communication apparatus 151 does not support the wireless LAN interface, and the sequence moves to step S512.

In step S502, based on the information pertaining to the connection forms supported by the communication apparatus 151 obtained in step S404, the CPU 103 determines whether the communication apparatus 151 is a model that supports the third setup. If the CPU 103 determines that the communication apparatus 151 is a model that supports the third setup, the sequence moves to step S503. However, if the CPU 103 determines that the communication apparatus 151 is a model that does not support the third setup, the sequence moves to step S505. Specifically, the CPU 103 refers to the wired connection information 1004 written in the model information file 1001 and determines whether the communication apparatus 151 supports the wired LAN interface. If the connection information 1004 is information indicating that the communication apparatus 151 supports the wired LAN interface, the CPU 103 determines that the communication apparatus 151 supports the wired LAN interface, and the sequence moves to step S503. However, if the connection information 1004 is information indicating that the communication apparatus 151 does not support the wired LAN interface, the CPU 103 determines that the communication apparatus 151 does not support the wired LAN interface, and the sequence moves to step S505.

In step S503, the CPU 103 accepts, from the user, a selection of the connection form between the communication apparatus 151 and the AP 131. Here, for example, the CPU 103 displays a network connection form selection screen 1221, illustrated in FIG. 12C, on the display unit 108. For example, the selection screen 1221 includes a region 1222 capable of accepting a selection of the wireless LAN connection form, a region 1223 capable of accepting a selection of the wired LAN connection form, a button 1224 capable of accepting an operation for displaying a next screen, and the like. In other words, the region 1222 is a region for establishing a connection between the information processing apparatus 101 and the communication apparatus 151 through the wireless LAN interface. Likewise, the region 1223 is a region for establishing a connection between the information processing apparatus 101 and the communication apparatus 151 through the wired LAN interface. Note that the network setup for establishing a connection between the information processing apparatus 101 and the communication apparatus 151 through the wireless LAN connection form (the wireless LAN guidance processing) includes the first setup and the second setup. The network setup for establishing a connection between the information processing apparatus 101 and the communication apparatus 151 through the wired LAN connection form (the wired LAN guidance processing) includes the third setup. In other words, the selection screen 1221 is an acceptance screen capable of accepting a selection of one of the wireless LAN guidance processing and the wired LAN guidance processing. When the user selects one of the region 1222 and the region 1223, and then presses the button 1224, the CPU 103 moves the sequence to step S504.

In step S504, the CPU 103 determines whether the region 1222 has been selected in the network connection form selection screen 1221. If the CPU 103 determines that the region 1222 has been selected, the sequence moves to step S505. In other words, the CPU 103 executes the wireless LAN guidance processing when the region 1222 is selected. However, if the CPU 103 determines that the wireless LAN connection form has not been selected, the sequence moves to step S512. In other words, the CPU 103 executes the wired LAN guidance processing when the region 1223 is selected.

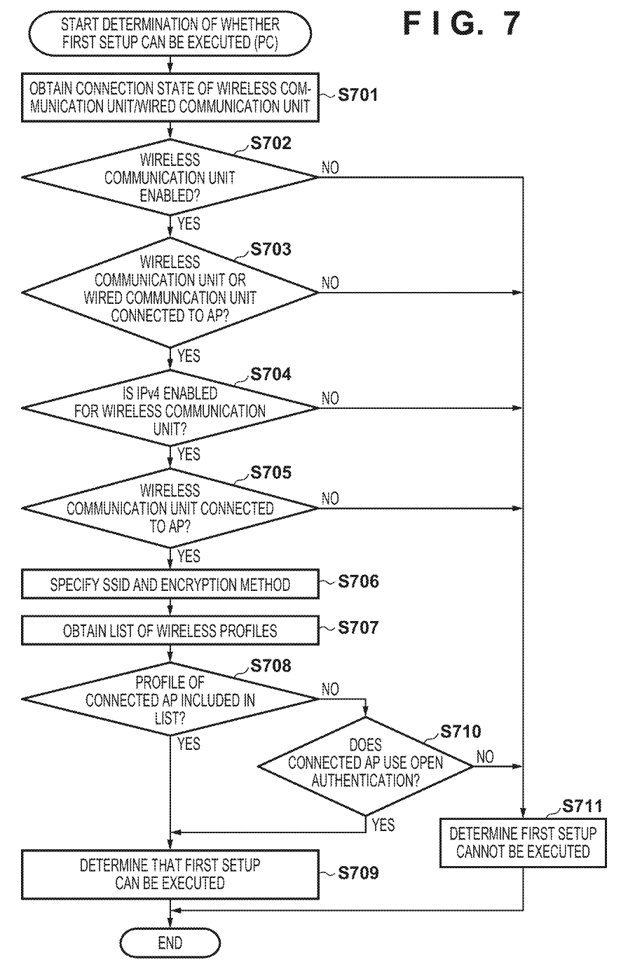

In step S505, the CPU 103 executes first setup executability determination processing for determining whether the first setup can be executed. The first setup executability determination processing will be described in detail later with reference to FIG. 7.

In step S506, the CPU 103 determines whether the first setup can be executed. If the CPU 103 determines that the first setup can be executed, the sequence moves to step S507. However, if the CPU 103 determines that the first setup cannot be executed, the sequence moves to step S511.

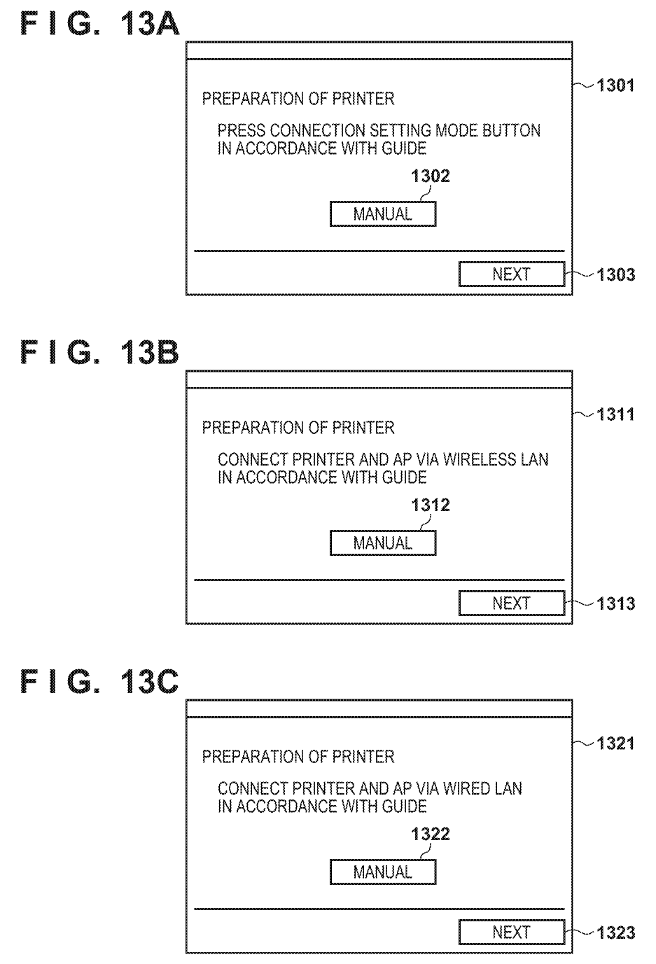

In step S507, the CPU 103 displays, on the display unit 108, a guidance screen 1301, illustrated in FIG. 13A, for guiding the user through a procedure for operating the communication apparatus 151 in the connection setting mode. For example, the guidance screen 1301 includes a “manual” button 1302 for displaying a manual describing a procedure for the user to operate the communication apparatus 151 in a connection setting mode in a web browser of the information processing apparatus 101, and a “next” button 1303 for displaying a next screen. The procedure itself for the user to operate the communication apparatus 151 in the connection setting mode may also be displayed in the guidance screen 1301. Specifically, for example, a message prompting the user to press the connection setting mode button of the communication apparatus 151 may be displayed in the guidance screen 1301.

In step S508, the CPU 103 searches for the communication apparatus 151 operating in the connection setting mode. Specifically, for example, using the wireless communication unit 109, the CPU 103 searches for a beacon including the connection setting SSID issued by a communication apparatus 151 operating in the connection setting mode.

In step S509, the CPU 103 determines whether a communication apparatus 151 operating in the connection setting mode has been detected. If the CPU 103 determines that a communication apparatus 151 operating in the connection setting mode has been detected (that a connection setting SSID has been detected), the sequence moves to step S510. However, if the CPU 103 determines that a communication apparatus 151 operating in the connection setting mode has not been detected (that a connection setting SSID has not been detected), the processing from step S508 is repeated.

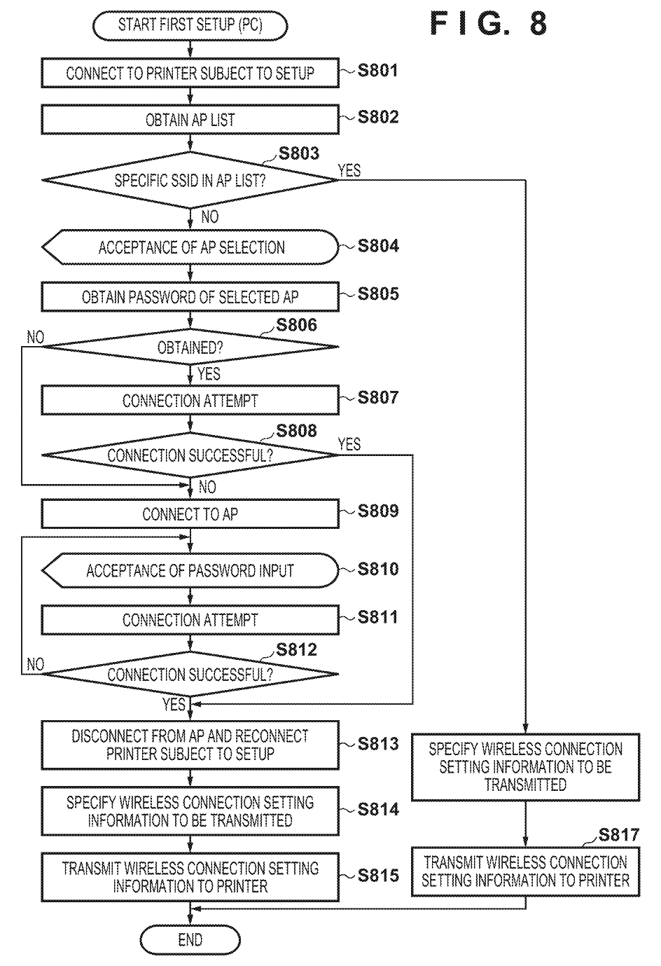

In step S510, the CPU 103 executes the first setup processing, after which the network connection method guidance processing illustrated in FIG. 5 ends. The first setup processing will be described later with reference to FIG. 8.

In step S511, the CPU 103 displays a guidance screen 1311 for guiding the user through the second setup procedure, illustrated in FIG. 13B, on the display unit 108. For example, the guidance screen 1311 displays a message prompting the communication apparatus 151 to be connected to an AP through wireless LAN. In other words, step S511 can also be said to be processing for notifying the user that they are to connect the communication apparatus 151 to the AP through the wireless LAN interface. The guidance screen 1311 also includes a “manual” button 1312 for displaying a manual describing an operation method for the user to perform the second setup in a web browser of the information processing apparatus 101, a “next” button 1313 for displaying a next screen, and the like. When the button 1312 is pressed, the CPU 103 launches the web browser of the information processing apparatus 101 and displays the manual in the web browser. Note that the configuration is not limited thereto, and the manual may be displayed directly in the setup application instead of in the web browser. When the user presses the button 1313, the CPU 103 ends the network connection method guidance processing illustrated in FIG. 5. Note that the configuration is not limited to one in which the guidance screen 1311 is displayed, and the CPU 103 may proceed with the processing after communicating the stated message, operation method, or the like by audio using a speaker (not shown) provided in the information processing apparatus 101.

In step S512, the CPU 103 executes the wired LAN guidance processing (third setup guidance processing). Specifically, the CPU 103 displays, on the display unit 108, a guidance screen 1321 for guiding the user through the third setup procedure, illustrated in FIG. 13C. The guidance screen 1321 displays a message prompting the communication apparatus 151 to be connected to an AP through wired LAN. In other words, step S512 can also be said to be processing for notifying the user that they are to connect the communication apparatus 151 to the AP through the wired LAN interface (the wired communication unit 162). The guidance screen 1321 also includes a “manual” button 1322 for displaying a manual describing an operation method for the user to perform the third setup in a web browser of the information processing apparatus 101, a “next” button 1323 for displaying a next screen, and the like. When the button 1322 is pressed, the CPU 103 launches the web browser of the information processing apparatus 101 and displays the manual in the web browser. Note that the configuration is not limited thereto, and the manual may be displayed directly in the setup application instead of in the web browser. Specifically, for example, the guidance screen 1321 may include a region prompting the user to connect the AP 131 and the communication apparatus 151 over a wired LAN (a LAN cable). When the user presses the button 1323, the network connection method guidance processing illustrated in FIG. 5 ends. Note that the configuration is not limited to one in which the guidance screen 1321 is displayed, and the CPU 103 may proceed with the processing after communicating the stated message, operation method, or the like by audio using a speaker (not shown) provided in the information processing apparatus 101.

Although the present embodiment describes a configuration in which the CPU 103 moves the sequence to step S502 when a determination of “YES” is made in step S501 (when the communication apparatus 151 is determined to support at least one of the first setup and the second setup), the configuration is not limited thereto. For example, the configuration may be such that if a determination of “YES” is made in step S501, the CPU 103 moves the sequence to step S505 (a configuration that omits the processing of steps S502 to S504). In this manner, the time until either of the first setup or the second setup is complete can be shortened by having the CPU 103 move the sequence to step S505 when a determination of “YES” is made in step S501, regardless of whether the communication apparatus 151 supports the third setup.

FIG. 6 is a flowchart illustrating an example of the print queue generation processing executed by the information processing apparatus 101. This flowchart is implemented, for example, by the CPU 103 reading out a program stored in the ROM 104 into the RAM 105 and executing the program. The processing illustrated in this flowchart corresponds to the processing performed in step S423.

In step S601, the CPU 103 displays a USB print queue generation confirmation screen 1231, illustrated in FIG. 12D, on the display unit 108. The confirmation screen 1231 includes a message prompting the user to confirm whether to generate a print queue associated with the USB port detected in step S402, a “yes” button 1233, and a “no” button 1232. The “yes” button 1233 is a button capable of accepting a selection for generating the print queue. The “no” button 1232 is a button capable of accepting a selection for not generating the print queue. In other words, the confirmation screen 1231 can also be said to be an acceptance screen capable of accepting a selection as to whether to generate a print queue associated with the USB port. When either the “yes” button 1233 or the “no” button 1232 is pressed, the CPU 103 moves the sequence to step S602.

In step S602, the CPU 103 determines whether the button pressed by the user on the confirmation screen 1231 displayed in step S601 is the “yes” button 1233. If the CPU 103 determines that the “yes” button 1233 was pressed, the sequence moves to step S603. However, if the CPU 103 determines that the “yes” button 1233 was not pressed, the CPU 103 moves the sequence to step S604.

In step S603, the CPU 103 generates a print queue associated with the USB port on which the communication apparatus 151 has been detected in step S402.

In step S604, the CPU 103 generates a print queue associated with a network port based on the IP address or host name of the communication apparatus 151 detected in step S418, and ends the print queue generation processing illustrated in FIG. 6.

FIG. 7 is a flowchart illustrating an example of the first setup executability determination processing executed by the information processing apparatus 101. This flowchart is implemented, for example, by the CPU 103 reading out a program stored in the ROM 104 into the RAM 105 and executing the program. The processing illustrated in this flowchart corresponds to the processing performed in step S505.

In step S701, the CPU 103 obtains information indicating connection states of the wireless communication unit 109 and the wired communication unit 112 from the OS of the information processing apparatus 101. The connection state of the wireless communication unit 109 is, in other words, a state of the connection of the information processing apparatus 101 through wireless LAN. The connection state of the wired communication unit 112 is, in other words, a state of the connection of the information processing apparatus 101 through wired LAN.

In step S702, the CPU 103 determines whether the wireless communication unit 109 is in an enabled state based on the information indicating the connection state obtained in step S701. If the CPU 103 determines that the wireless communication unit 109 is in the enabled state, the sequence moves to step S703. However, if the CPU 103 determines that the wireless communication unit 109 is not in the enabled state, the sequence moves to step S711.

In step S703, based on the information indicating the connection state obtained in step S701, the CPU 103 determines whether the information processing apparatus 101 is connected to the AP 131 through at least one of the wireless communication unit 109 and the wired communication unit 112. If the CPU 103 determines that such a connection is established, the sequence moves to step S704. However, if the CPU 103 determines that such a connection is not established, the sequence moves to step S711.

In step S704, based on the information indicating the connection state obtained in step S701, the CPU 103 determines whether communication by the wireless communication unit 109 using IPv4 is enabled. If the CPU 103 determines that communication performed by the wireless communication unit 109 using IPv4 is enabled, the sequence moves to step S705. However, if the CPU 103 determines that communication performed by the wireless communication unit 109 using IPv4 is not enabled, the sequence moves to step S711.

In step S705, based on the information indicating the connection state obtained in step S701, the CPU 103 determines whether the information processing apparatus 101 is connected to the AP 131 through the wireless communication unit 109. If the CPU 103 determines that the wireless communication unit 109 is connected to the AP 131, the sequence moves to step S706. However, if the CPU 103 determines that the wireless communication unit 109 is not connected to the AP 131, the sequence moves to step S711.

In step S706, the CPU 103 specifies the SSID of the AP 131 to which the information processing apparatus 101 is connected and the encryption method used by the AP 131 to which the information processing apparatus 101 is connected.

In step S707, the CPU 103 obtains a list of the wireless profiles held by the information processing apparatus 101 from the OS of the information processing apparatus 101. The wireless profiles held by the information processing apparatus 101 are information pertaining to the APs to which the information processing apparatus 101 has previously connected. Specifically, each wireless profile held by the information processing apparatus 101 is the SSID of an AP to which the information processing apparatus 101 has previously connected, the password for connecting to the AP to which the information processing apparatus 101 has previously connected, and the like.

In step S708, the CPU 103 determines whether a wireless profile corresponding to the AP 131 to which the information processing apparatus 101 is connected is included in the list of wireless profiles obtained in step S707. If the CPU 103 determines that a wireless profile corresponding to the AP 131 to which the information processing apparatus 101 is connected is included in the list of wireless profiles, the sequence moves to step S709. However, if the CPU 103 determines that a wireless profile corresponding to the AP 131 to which the information processing apparatus 101 is connected is not included in the list of wireless profiles, the sequence moves to step S710.

In step S709, the CPU 103 determines that the first setup can be executed, and the first setup executability determination processing illustrated in FIG. 7 ends.

In step S710, based on the encryption method obtained in step S706, the CPU 103 determines whether the AP 131 to which the information processing apparatus 101 is connected uses open authentication. If the CPU 103 determines that the AP 131 to which the information processing apparatus 101 is connected uses open authentication, the sequence moves to step S709, after which the first setup executability determination processing illustrated in FIG. 7 ends. However, if the CPU 103 determines that the AP 131 to which the information processing apparatus 101 is connected does not use open authentication, the sequence moves to step S711.

In step S711, the CPU 103 determines that the first setup cannot be executed, and the first setup executability determination processing illustrated in FIG. 7 ends.

FIG. 8 is a flowchart illustrating an example of the first setup processing executed by the information processing apparatus 101. This flowchart is implemented, for example, by the CPU 103 reading out a program stored in the ROM 104 into the RAM 105 and executing the program. The processing illustrated in this flowchart corresponds to the processing performed in step S510.

In step S801, the CPU 103 establishes the wireless connection 143 between the information processing apparatus 101 and the communication apparatus 151 by setting the SSID indicating the connection destination of the information processing apparatus 101 to the connection setting SSID. Specifically, for example, the CPU 103 causes the information processing apparatus 101 to connect to the AP 156-a corresponding to the connection setting SSID by executing an API of the OS.

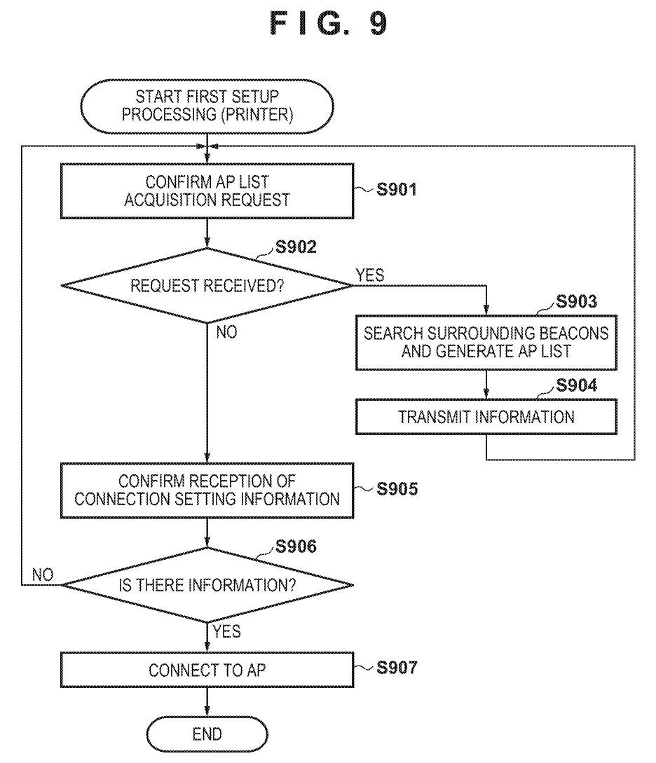

In step S802, the CPU 103 makes a request to obtain APs to the communication apparatus 151, and obtains a list of the APs from the communication apparatus 151. The list of APs is a list of surrounding APs detected by a search (an AP search) performed by the communication apparatus 151. In other words, the list of APs is a list of surrounding APs to which the communication apparatus 151 can connect. Specifically, the list of APs includes, for example, the SSID of each AP detected through a search of surrounding beacons, executed by the communication apparatus 151, and information about the encryption method used by each AP detected by the search of the surrounding beacons, executed by the communication apparatus 151. The processing executed by the communication apparatus 151 in the processing of step S802 will be described later with reference to FIG. 9.

In step S803, the CPU 103 determines whether the SSID of the AP 131 to which the information processing apparatus 101 was connected is among the SSIDs indicated in the list of APs obtained in step S802. If the CPU 103 determines that the SSID of the AP 131 to which the information processing apparatus 101 was connected is included, the sequence moves to step S816. However, if the CPU 103 determines that the SSID of the AP 131 to which the information processing apparatus 101 was connected is not included, the sequence moves to step S804.

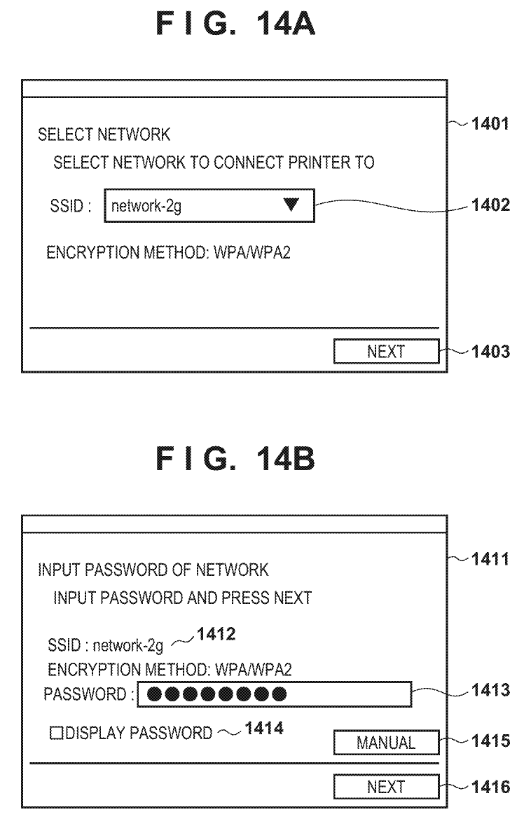

In step S804, the CPU 103 displays the list of APs obtained in step S802, and accepts the selection of one of the APs. The selection of the AP is, in other words, a selection of the corresponding SSID. Specifically, for example, the CPU 103 displays an SSID selection screen 1401, illustrated in FIG. 14A, on the display unit 108. The SSID selection screen 1401 displayed here includes a pull-down menu 1402 and a “next” button 1403. The SSID selection screen 1401 may also include a message indicating a reason why the SSID of the AP 131 to which the information processing apparatus 101 was connected was not among the SSIDs indicated in the list of APs obtained in step S802. The reason may be, for example, a message indicating that the communication apparatus 151 does not support communication using the 5 GHz frequency band. The pull-down menu is a menu that, when operated by the user, displays the SSIDs in the list of APs obtained in step S802. After selecting the pull-down menu 1402, the user selects one of the SSIDs from the list of APs. The “next” button 1403 may be grayed out, so that the button cannot be pressed by the user, until one of the SSIDs is selected by the user. When one of the SSIDs is selected by the user, the SSID selected by the user is displayed in the pull-down menu 1402. Furthermore, the SSID selection screen 1401 may display the MAC address of the AP corresponding to the SSID selected by the user, the encryption method used by the AP corresponding to the SSID selected by the user, and the like. Then, when the “next” button 1403, which is enabled when one of the SSIDs was selected, is pressed by the user, the sequence moves to step S805.

In step S805, the CPU 103 attempts to obtain the password for connecting to the AP corresponding to the SSID selected in step S804 from the wireless profile saved by the OS of the information processing apparatus 101. The CPU 103 obtains the password for connecting to the AP corresponding to the SSID selected in step S804 from the wireless profile saved by the OS of the information processing apparatus 101 by executing an API for obtaining the password from the wireless profile.

In step S806, the CPU 103 determines whether the password for connecting to the AP corresponding to the SSID selected in step S804 has been successfully obtained from the wireless profile saved by the OS of the information processing apparatus 101. If the AP corresponding to the SSID selected in step S804 and the information processing apparatus 101 have previously connected to each other through wireless LAN, and the wireless profile corresponding to the SSID selected in step S804 has been saved by the OS of the information processing apparatus 101, the password for connecting to the AP corresponding to the SSID selected in step S804 is successfully obtained. However, if the AP corresponding to the SSID selected in S804 and the information processing apparatus 101 have not previously connected to each other through wireless LAN, or if the AP corresponding to the SSID selected in S804 and the information processing apparatus 101 have previously connected to each other through wireless LAN but the wireless profile corresponding to the SSID selected in S804 has been deleted, the obtainment of the password for connecting to the AP corresponding to the SSID selected in S804 fails. If the obtainment of the password is determined to have succeeded, the sequence moves to step S807, whereas if the obtainment of the password is determined to have failed, the sequence moves to step S809.

In step S807, the CPU 103 terminates the connection with the AP corresponding to the connection setting SSID of the communication apparatus 151, and attempts to establish a wireless connection between the AP corresponding to the SSID selected in step S804 and the information processing apparatus 101 using the password obtained in step S805. Specifically, for example, by executing an API of the OS, the CPU 103 disconnects the AP corresponding to the connection setting SSID and attempts to connect to the AP corresponding to the SSID selected in step S804.

In step S808, the CPU 103 determines whether the attempt to make a connection in step S807 has succeeded in establishing a wireless connection between the AP corresponding to the SSID selected in step S804 and the information processing apparatus 101. If the establishment of the wireless connection is determined to have succeeded, the sequence moves to step S813. However, if the establishment of the wireless connection is determined not to have succeeded, the sequence moves to step S809.

In step S809, the CPU 103 terminates the connection with the AP corresponding to the connection setting SSID, and re-establishes the wireless connection 141 between the AP 131 and the information processing apparatus 101. Specifically, for example, the CPU 103 establishes a wireless connection 141 between the AP 131 and the information processing apparatus 101 by executing an API of the OS.

In step S810, the CPU 103 displays a password input screen 1411 including the display content illustrated in FIG. 14B on the display unit 108, and accepts the input of a password for connecting to the AP corresponding to the SSID selected in step S804. The password input screen 1411 includes information 1412 of the SSID selected in step S804, a password input box 1413, a check box 1414, a “manual” button 1415, and a “next” button 1416. The password input box 1413 is a box for accepting, from the user, the input of a password for connecting to the AP corresponding to the SSID selected in step S404. The check box 1414 is a box for switching between displaying the password input to the password input box 1413 as visible, plain text, or as asterisks to hide the text thereof. The “manual” button 1415 is a button capable of accepting an operation that triggers processing for displaying, as Internet content, a web manual for presenting a method for confirming the password to a user, using a web browser or the like, for example. When a password is input to the password input box 1413, the “next” button 1416 is enabled, and can then be pressed by the user. The sequence moves to step S811 when the “next” button 1416 is pressed.

In step S811, the CPU 103 terminates the wireless connection 141 established in step S809, and attempts to establish a wireless connection between the AP corresponding to the SSID selected in step S804 and the information processing apparatus 101 using the password input in the password input screen 1411. Specifically, for example, by executing an API of the OS, the CPU 103 terminates the wireless connection 141 with the AP 131, and attempts to connect to the AP corresponding to the SSID selected in step S804.

In step S812, the CPU 103 determines whether the attempt to make a connection in step S811 has succeeded in establishing a wireless connection between the AP corresponding to the SSID selected in step S804 and the information processing apparatus 101. If the establishment of the connection is determined not to have succeeded, the processing from step S810 is repeated. However, if the establishment of the connection is determined to have succeeded, the sequence moves to step S813.

In step S813, the CPU 103 terminates the wireless connection between the AP corresponding to the SSID selected in step S804 and the information processing apparatus 101, and causes the information processing apparatus 101 to connect to the AP corresponding to the connection setting SSID issued by the communication apparatus 151 again. Specifically, for example, by executing an API of the OS, the CPU 103 terminates the wireless connection with the AP corresponding to the SSID selected in step S804 and connects the information processing apparatus 101 to the AP corresponding to the connection setting SSID.

In step S814, the CPU 103 specifies the SSID selected in step S804 and the password obtained in step S805 or step S810 as the connection setting information to be transmitted to the communication apparatus 151. Note that the CPU 103 may specify other information in addition to the stated information, such as the frequency band, the encryption method, or the like used by the AP corresponding to the SSID selected in step S804.

In step S815, the CPU 103 transmits the connection setting information to the communication apparatus 151, after which the first setup processing illustrated in FIG. 8 ends. The connection setting information transmitted in step S815 includes information such as the SSID, the password, and the like specified in the processing of step S814, and a command for setting the communication apparatus 151 to the infrastructure connection mode. As a result of the connection setting information being transmitted to the communication apparatus 151 in step S815, the communication apparatus 151 starts operating in the infrastructure connection mode, and connects to the AP based on the connection setting information. In other words, in step S815, the CPU 103 transmits the connection setting information, which is information for connecting the communication apparatus 151 to the AP through the wireless LAN interface, to the communication apparatus 151.

In step S816, the CPU 103 specifies, in the wireless profile held by the information processing apparatus 101, the SSID of the AP 131 to which the information processing apparatus 101 was connected, and the password, as the connection setting information to be transmitted to the communication apparatus 151. Note that the CPU 103 may specify other information in addition to the information described above, such as the frequency band, the encryption method, or the like used by the AP 131 to which the information processing apparatus 101 was connected.

In step S817, the CPU 103 transmits the connection setting information for setting the infrastructure connection mode to the communication apparatus 151, after which the first setup processing illustrated in FIG. 8 ends. The connection setting information transmitted in step S817 includes information such as the SSID, the password, and the like specified in the processing of step S816, and a command for setting the communication apparatus 151 to the infrastructure connection mode. As a result of the connection setting information being transmitted to the communication apparatus 151 in step S817, the communication apparatus 151 starts operating in the infrastructure connection mode, and connects to the AP based on the connection setting information. In other words, in step S817, the CPU 103 transmits the connection setting information, which is information for connecting the communication apparatus 151 to the AP through the wireless LAN interface, to the communication apparatus 151.

FIG. 9 is a flowchart illustrating the connection setting processing executed by the communication apparatus 151. This flowchart is implemented by the CPU 154 reading out a program stored in the ROM 152 into the RAM 153 and executing the program, for example. This flowchart is started based on the communication apparatus 151 accepting a user operation for operating in the connection setting mode, for example. In other words, the communication apparatus 151 starts operating in connection setting mode based on the trigger described above.

When the information processing apparatus 101 connects to the AP corresponding to the connection setting SSID and the wireless connection 143 is established, in step S901, the CPU 154 confirms whether the information processing apparatus 101 has made a request to obtain the list of APs.

In step S902, the CPU 154 determines whether the information processing apparatus 101 has made the request to obtain the list of APs (whether the request to obtain the list of APs has been received). If the CPU 154 determines that the request to obtain the list of APs has been received, the sequence moves to step S903. However, if the CPU 154 determines that the request to obtain the list of APs has not been received, the CPU 154 moves the sequence to step S905. If the information processing apparatus 101 has made the request for the list of APs in step S802, the request to obtain the list of the APs is determined to have been received in step S902.

In step S903, the CPU 154 searches the surrounding beacons using the wireless communication unit 156, obtains information about the SSIDs included in the discovered beacons, and generates a list of APs based on the information about the obtained SSIDs.

In step S904, the CPU 154 transmits the list of APs generated in step S903 to the information processing apparatus 101 that made the request. After step S904, the processing is repeated from step S901.

In step S905, the CPU 154 confirms whether the connection setting information has been received from the information processing apparatus 101.

In step S906, the CPU 154 determines whether the connection setting information has been received from the information processing apparatus 101. If the CPU 154 determines that the connection setting information has not been received, the processing from step S901 is repeated. However, if the CPU 154 determines that the connection setting information has been received, the sequence moves to step S907.

In step S907, the CPU 154 changes the operating mode of the communication apparatus 151 from the connection setting mode to the infrastructure connection mode, after which the connection setting processing illustrated in FIG. 9 ends. Specifically, the CPU 154 disables the AP 156-a having the connection setting SSID by terminating the connection setting mode, for example. The CPU 154 then obtains the SSID included in the connection setting information for setting the infrastructure connection mode, transmitted from the information processing apparatus 101, and connects to the AP corresponding to the SSID. Due to the communication apparatus 151 establishing the wireless LAN connection 142, an infrastructure connection can be established between the communication apparatus 151 and the information processing apparatus 101.

As described thus far, according to the present embodiment, the setup app causes the CPU 103 to execute processing such as that described below. Upon detecting a communication apparatus 151 connected to the information processing apparatus 101 only through the USB interface, the CPU 103 displays the guidance screen 1211 based on the initial setting of the communication apparatus 151 being complete. Displaying the guidance screen 1211 even when the communication apparatus 151 has been connected to the information processing apparatus 101 by USB enables the user to recognize that an external interface can be used. Additionally, the guidance screen 1211 is displayed when the initial setting of the communication apparatus 151 is complete. This makes it possible to display the guidance screen 1211 to the user in a state where the communication apparatus 151 to be set up can operate in the connection setting mode, even if the communication apparatus 151 is a specific model. Through such a configuration, the usability when connecting the communication apparatus 151 to the information processing apparatus 101 can be improved.

### Second Embodiment

A second embodiment will be described hereinafter, focusing on differences from the first embodiment. In the first embodiment, if the initial setting of the communication apparatus 151 is determined to be incomplete, the CPU 103 displays the guidance screen 1201 for the initial setting operations.

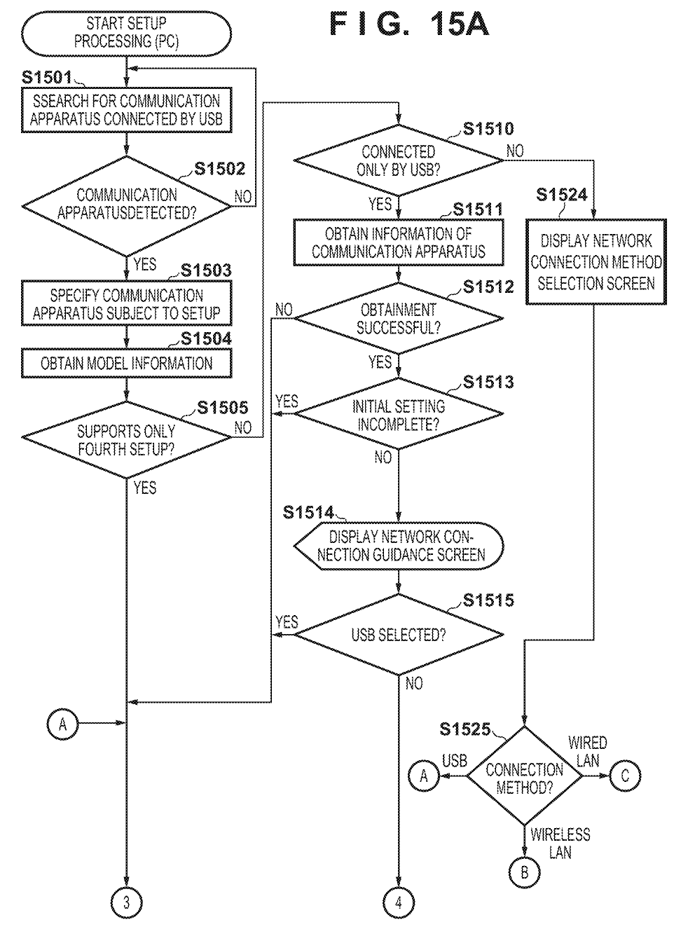

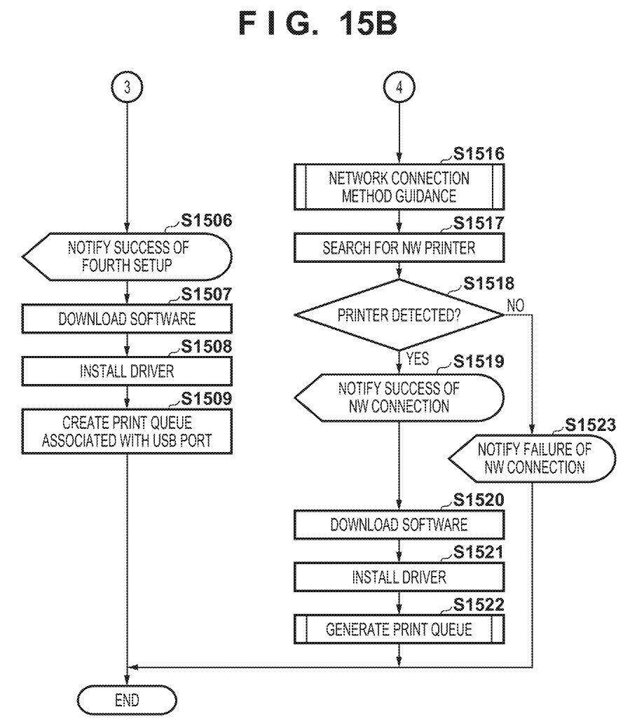

The present embodiment will describe setup processing in which the initial setting operation guidance screen 1201 is not displayed, with reference to FIGS. 15A and 15B.

FIGS. 15A and 15B are flowcharts illustrating an example of the setup processing executed by the information processing apparatus 101 according to the present embodiment. The setup processing illustrated in FIGS. 15A and 15B is realized, for example, by the CPU 103 reading out a program stored in the ROM 104 into the RAM 105 and executing the program. The CPU 103 starts the processing illustrated in FIGS. 15A and 15B based on a user operation for executing the setup app made through the input interface 102 of the information processing apparatus 101.

The processing of steps S1501 to S1512 in FIGS. 15A and 15B is the same as that of steps S401 to S412, and will therefore not be described here.

In step S1513, the CPU 103 determines whether the initial setting of the communication apparatus 151 is incomplete based on the information about the communication apparatus 151 obtained in step S1511. If the CPU 103 determines that the initial setting of the communication apparatus 151 is incomplete, the sequence moves to step S1506. However, if the CPU 103 determines that the initial setting of the communication apparatus 151 is complete, the sequence moves to step S1514. In this manner, in the present embodiment, if the initial setting of the communication apparatus 151 is incomplete, the CPU 103 moves the sequence to step S1506, and displays the fourth setup success screen 1101 on the display unit 108.

The processing of steps S1514 to S1525 is the same as that of steps S415 to S426, and will therefore not be described here.

As described thus far, in the present embodiment, if the initial setting of the communication apparatus 151 is not complete, the fourth setup is executed without displaying the initial setting operation guidance screen 1201. This configuration is suitable for a user who wishes to execute the initial setting operation at any desired timing without being rushed.

### Third Embodiment

A third embodiment will be described next, focusing on differences from the first embodiment and the second embodiment. The foregoing embodiments described setup processing in which the communication apparatus 151 to be set up is assumed to be a model in which the connection setting mode is terminated during a USB connection and which requires the initial setting to be complete in order to resume the connection setting mode. In the foregoing embodiments, when a communication apparatus 151 connected to the information processing apparatus 101 only through the USB interface is detected, the CPU 103 obtains information about the communication apparatus 151. The CPU 103 then executes processing according to whether the initial setting of the communication apparatus 151 is incomplete.

In the present embodiment, the communication apparatus 151 does not terminate the connection setting mode when connected to the information processing apparatus 101 by USB, but rather keeps operating in the connection setting mode. The present embodiment will describe setup processing assuming that the communication apparatus 151 to be set up is a model in which the connection setting mode is not terminated even when the communication apparatus 151 is connected to the information processing apparatus 101 by USB.

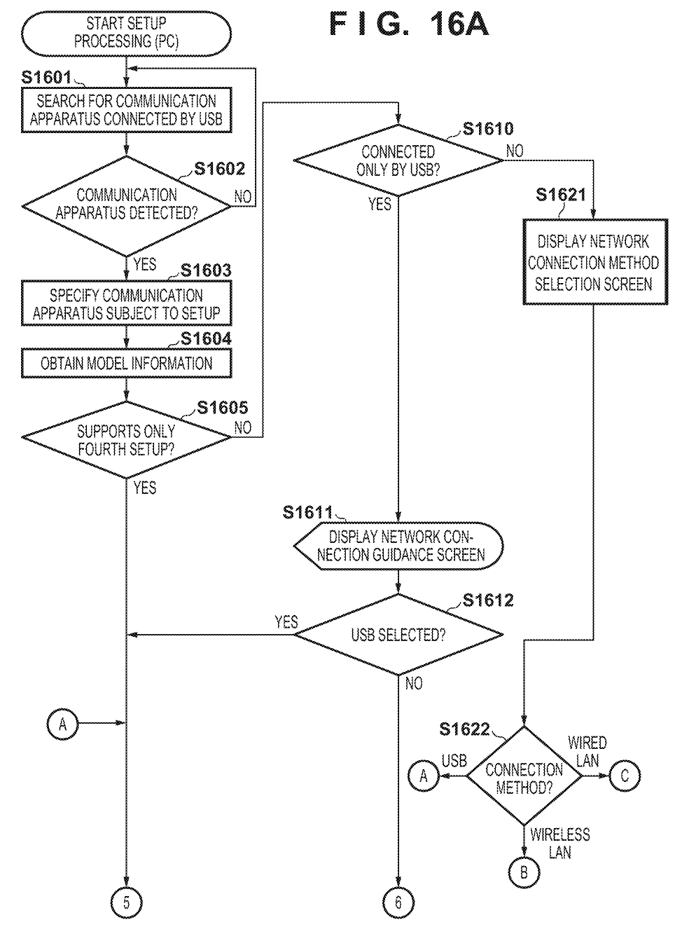

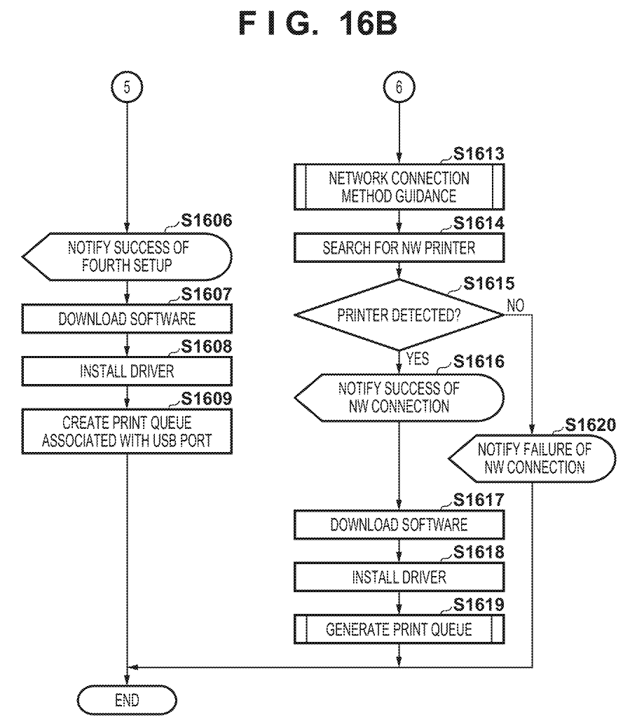

FIGS. 16A and 16B is a flowchart illustrating an example of the setup processing executed by the information processing apparatus 101 according to the present embodiment. The setup processing illustrated in FIGS. 16A and 16B is realized, for example, by the CPU 103 reading out a program stored in the ROM 104 into the RAM 105 and executing the program. The CPU 103 starts the processing illustrated in FIGS. 16A and 16B based on a user operation for executing the setup app made through the input interface 102 of the information processing apparatus 101.

The processing of steps S1601 to S1609 in FIGS. 16A and 16B is the same as that of steps S401 to S409, and will therefore not be described here.

In step S1610, the CPU 103 determines whether the communication apparatus 151 specified in step S1603 is a communication apparatus 151 detected (discovered) only through the search performed through the USB interface in step S1601. If the CPU 103 determines that the communication apparatus 151 specified in step S1603 is a communication apparatus 151 detected only through the search performed through the USB interface, the sequence moves to step S1611. However, if the CPU 103 determines that the communication apparatus 151 specified in step S1603 is not a communication apparatus 151 discovered only through the search performed through the USB interface, the sequence moves to step S1621.

The processing of steps S1611 to S1622 is the same as that of steps S415 to S426, and will therefore not be described here.

The present embodiment has described setup processing assuming that the communication apparatus 151 to be set up is a model in which the connection setting mode is not terminated even when a USB connection is established. In the present embodiment, the CPU 103 displays the guidance screen 1211 when a communication apparatus 151 connected to the information processing apparatus 101 only through the USB interface is determined to have been detected. Through such a configuration, when the communication apparatus 151 is connected to the information processing apparatus 101 by USB, the guidance screen 1211 can be displayed immediately, which makes it possible to further improve the usability.

According to the present disclosure, a technique for improving usability when connecting a communication apparatus to an information processing apparatus can be provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-011658, filed January 27, 2025 which is hereby incorporated by reference herein in its entirety.

What is claimed is:

1. A non-transitory computer-readable storage medium storing a program configured to cause a computer of an information processing apparatus to function as:
a detecting unit configured to detect a communication apparatus connected to the information processing apparatus; and
a display unit configured to, in a case where the communication apparatus that is connected to the information processing apparatus only through a Universal Serial Bus (USB) interface is detected, display a guidance screen for accepting a designation of an external interface to be used for connecting the communication apparatus to the information processing apparatus.

2. The non-transitory computer-readable storage medium according to claim 1, wherein the program is configured to cause the computer to further function as:
an executing unit configured to, in a case where designation of an external interface of a type different from the USB interface is accepted via the guidance screen, execute predetermined processing for connecting the communication apparatus to the information processing apparatus through the external interface of the type different from the USB interface.

3. The non-transitory computer-readable storage medium according to claim 2, wherein the program is configured to cause the computer to further function as:
a first accepting unit configured to accept a selection of whether to generate a print queue that is associated with the USB interface, in a case where the predetermined processing is executed by the executing unit and the communication apparatus is connected to the information processing apparatus through the external interface of the type different from the USB interface; and
a generating unit configured to generate the print queue in a case where the first accepting unit accepts a selection for generating the print queue.

4. The non-transitory computer-readable storage medium according to claim 2,
wherein as the predetermined processing, the executing unit executes one of first processing for connecting the communication apparatus to the information processing apparatus through a wireless LAN interface and second processing for connecting the communication apparatus to the information processing apparatus through a wired LAN interface.

5. The non-transitory computer-readable storage medium according to claim 4,
wherein the first processing includes processing of transmitting, to the communication apparatus, connection setting information for connecting the communication apparatus to an external access point through the wireless LAN interface.

6. The non-transitory computer-readable storage medium according to claim 4,
wherein the first processing includes processing of notifying a user to connect the communication apparatus to an external access point through the wireless LAN interface.

7. The non-transitory computer-readable storage medium according to claim 4,
wherein the second processing includes processing of notifying a user to connect the communication apparatus to an external access point through the wired LAN interface.

8. The non-transitory computer-readable storage medium according to claim 4, wherein the program is configured to cause the computer to further function as:
a first obtaining unit configured to, in a case where the communication apparatus is detected by the detecting unit, obtain information about an external interface supported by the communication apparatus, and
the executing unit executes one of the first processing and the second processing based on the information about the external interface supported by the communication apparatus, obtained by the first obtaining unit.

9. The non-transitory computer-readable storage medium according to claim 8, wherein the program is configured to cause the computer to further function as:
a second accepting unit configured to accept a selection of one of the first processing and the second processing in a case where the information about the external interface supported by the communication apparatus includes information indicating that the communication apparatus supports the wireless LAN interface and the wired LAN interface,
the executing unit executes the first processing in a case where the second accepting unit accepts a selection of the first processing, and
the executing unit executes the second processing in a case where the second accepting unit accepts a selection of the second processing.

10. The non-transitory computer-readable storage medium according to claim 8,
wherein the executing unit executes the first processing in a case where the information about the external interface supported by the communication apparatus includes information indicating that the communication apparatus supports the wireless LAN interface and furthermore does not include information indicating that the communication apparatus supports the wired LAN interface.

11. The non-transitory computer-readable storage medium according to claim 8,
wherein the executing unit executes the second processing in a case where the information about the external interface supported by the communication apparatus does not include information indicating that the communication apparatus supports the wireless LAN interface.

12. The non-transitory computer-readable storage medium according to claim 1, wherein the program is configured to cause the computer to further function as:
a second obtaining unit configured to, in a case where the communication apparatus that is connected to the information processing apparatus only through the USB interface is detected, obtain information indicating whether initial setting of the communication apparatus is complete, and
the display unit displays the guidance screen in a case where the information indicating that the initial setting is complete is obtained by the second obtaining unit.

13. The non-transitory computer-readable storage medium according to claim 12, wherein the program is configured to cause the computer to further function as:
a first notifying unit configured to notify a user of a procedure of the initial setting, in a case where information indicating that the initial setting is not complete is obtained by the second obtaining unit.

14. The non-transitory computer-readable storage medium according to claim 12, wherein the program is configured to cause the computer to further function as:
a second notifying unit configured to notify a user that the communication apparatus is connected to the information processing apparatus through the USB interface, in a case where information indicating the initial setting is not complete is obtained by the second obtaining unit.

15. The non-transitory computer-readable storage medium according to claim 1,
wherein the display unit displays, in the guidance screen, a benefit of designating an external interface of a type different from the USB interface.

16. The non-transitory computer-readable storage medium according to claim 1,
wherein the display unit displays, in the guidance screen, a message prompting designation of an external interface of a type different from the USB interface.

17. An information processing apparatus comprising:
at least one memory and at least one processor which function as:
a detecting unit configured to detect a communication apparatus connected to the information processing apparatus; and
a display unit configured to, in a case where the communication apparatus that is connected to the information processing apparatus only through a Universal Serial Bus (USB) interface is detected, display a guidance screen for accepting a designation of an external interface to be used for connecting the communication apparatus to the information processing apparatus.

18. A method executed by an information processing apparatus, the method comprising:
detecting a communication apparatus connected to the information processing apparatus; and
in a case where the communication apparatus that is connected to the information processing apparatus only through a Universal Serial Bus (USB) interface is detected, displaying a guidance screen for accepting a designation of an external interface to be used for connecting the communication apparatus to the information processing apparatus.
